(19) United States
(12) Patent Application Publication
(10) Pub. No.: US 2024/0421733 A1
(43) Pub. Date: Dec. 19, 2024

(54) POWER TOOL CONTROLLING FIELD WEAKENING

(71) Applicant: MILWAUKEE ELECTRIC TOOL CORPORATION, Brookfield, WI (US)

(72) Inventors: Ryan Khatib, Waukesha, WI (US); Mitchell A. Ellena, West Allis, WI (US); Jonathon R. Gasteiner, Brookfield, WI (US); Lokeshwaran Rajendran, West Allis, WI (US); Vincent Zornow, Milwaukee, WI (US)

(21) Appl. No.: 18/704,283

(22) PCT Filed: Jan. 13, 2023
(86) PCT No.: PCT/US2023/060605

§ 371 Date: Apr. 24, 2024

Related U.S. Application Data
(60) Provisional application No. 63/369,796, filed on Jul. 29, 2022.
(60) Provisional application No. 63/299,738, filed on Jan. 14, 2022.

(51) Int. Cl. H02P 21/00; B25C 1/06; H02P 21/18

(52) U.S. Cl. CPC H02P 21/0089; B25C 1/06; H02P 21/18

(57) ABSTRACT

A power tool that includes a housing, a brushless motor, a power switching circuit, and an electronic controller. The brushless motor is within the housing. The brushless motor includes a rotor and a stator. The rotor is coupled to a motor shaft arranged to rotate about a longitudinal axis. The motor shaft is arranged to produce a rotational output to a drive mechanism. The power switching circuit provides a supply of power from a battery pack to the brushless motor. The electronic controller is configured to determine a parameter associated with the battery pack, assign a classification to the battery pack based on the determined parameter, and control field weakening applied to the brushless motor based on the classification of the battery pack.

### RELATED APPLICATIONS

This application claims the benefit of U.S. Provisional Patent Application No. 63/299,738, filed Jan. 14, 2022, and U.S. Provisional Patent Application No. 63/369,796, Filed Jul. 29, 2022, the entire content of each of which is hereby incorporated by reference.

### FIELD

Embodiments described herein relate to power tools.

### SUMMARY

Power tools described herein include a housing, a brushless motor, a power switching circuit, and an electronic controller. The brushless motor is within the housing. The brushless motor includes a rotor and a stator. The rotor is coupled to a motor shaft arranged to rotate about a longitudinal axis. The motor shaft is arranged to produce a rotational output to a drive mechanism. The power switching circuit provides a supply of power from a battery pack to the brushless motor. The electronic controller is configured to determine a parameter associated with the battery pack, assign a classification to the battery pack based on the determined parameter, and control field weakening applied to the brushless motor based on the classification of the battery pack.

Nailers described herein include a housing, a brushless motor, a power switching circuit, a driver blade, and an electronic controller. The brushless motor is within the housing. The brushless motor includes a rotor and a stator. The rotor is coupled to a motor shaft arranged to rotate about a longitudinal axis. The longitudinal axis extends through the motor shaft. The motor shaft is arranged to produce a rotational output to a drive mechanism. The power switching circuit provides a supply of power from a battery pack to the brushless motor. The driver blade is configured to be driven by the drive mechanism between a first position and a second position. The electronic controller is configured to determine whether the driver blade is in the first position, and apply, in response to determining that the driver blade is in the first position, field weakening to the brushless motor while the driver blade is moved from the first position to the second position.

In some aspects, the electronic controller is further configured to determine whether the driver blade is in the second position, and terminate, in response to determining that the driver blade is in the second position, field weakening to the brushless motor.

In some aspects, the nailers described herein further include a sensor configured to generate a sensor signal, and the electronic controller is further configured to receive the sensor signal from the sensor.

In some aspects, the electronic controller is further configured to determine whether the driver blade is in the first position based on the sensor signal.

In some aspects, the sensor is a Hall effect sensor.

In some aspects, the electronic controller is further configured to apply a phase advance angle to control the brushless motor.

In some aspects, the electronic controller is further configured to apply a field-oriented control (“FOC”) algorithm to control the brushless motor.

Methods described herein for controlling a nailer including an electronic controller and a driver blade configured to be driven by a drive mechanism between a first position and a second position. The methods include determining whether the driver blade is in the first position, and applying, in response to determining that the driver blade is in the first position, field weakening to a brushless motor while the driver blade is moved from the first position to the second position.

In some aspects, the methods described herein further include determining whether the driver blade is in the second position, and terminating, in response to determining that the driver blade is in the second position, field weakening to the brushless motor.

In some aspects, the methods described herein further include receiving, at the electronic controller, a sensor signal from a sensor.

In some aspects, the methods described herein further include determining whether the driver blade is in the first position based on the sensor signal.

In some aspects, the sensor is a Hall effect sensor.

In some aspects, the methods described herein further include applying a phase advance angle to control the brushless motor.

In some aspects, the methods described herein further include applying a field-oriented control (“FOC”) algorithm to control the brushless motor.

Power tools described herein include a housing, a brushless motor, a power switching circuit, and an electronic controller. The brushless motor is within the housing. The brushless motor includes a rotor and a stator. The rotor is coupled to a motor shaft arranged to rotate about a longitudinal axis. The longitudinal axis extends through the motor shaft. The motor shaft is arranged to produce a rotational output to a drive mechanism. The power switching circuit provides a supply of power from a battery pack interface to the brushless motor. The electronic controller is configured to determine a parameter associated with the battery pack, classify the battery pack based on the determined parameter, and control field weakening applied to the brushless motor based on the classification of the battery pack.

In some aspects, the electronic controller is further configured to apply, in response to classifying the battery pack as a high-capacity battery pack, field weakening to the brushless motor.

In some aspects, the electronic controller is further configured to disable, in response to classifying the battery pack as a low-capacity battery pack, field weakening to the brushless motor.

In some aspects, the electronic controller is further configured to adjust the field weakening applied to the brushless motor based the parameter associated with the battery pack.

In some aspects, the parameter is a state-of-charge of the battery pack, and the electronic controller is further configured to adjust the field weakening applied to the brushless motor based on the state-of-charge of the battery pack.

In some aspects, the parameter is a temperature of the battery pack, and the electronic controller is further configured to adjust the field weakening applied to the brushless motor based on the temperature of the battery pack.

In some aspects, the electronic controller is further configured to receive a first indication associated with a first operating mode of the power tool. The first operating mode includes a first set of operating parameters that enable field weakening. The electronic controller is further configured to control, in response to receiving the first indication associated with the first operating mode of the power tool, operation of the brushless motor according to the first operating mode, and receive a second indication associated with a second operating mode of the power tool. The second operating mode includes a second set of operating parameters that disable field weakening. The electronic controller is further configured to control, in response to receiving the second indication associated with the second operating mode of the power tool, operation of the brushless motor according to the second operating mode.

In some aspects, the parameter associated with the battery pack is an identification of the battery pack.

In some aspects, the parameter associated with the battery pack is an impedance of the battery pack.

In some aspects, the parameter associated with the battery pack is an ampere-hour capacity of the battery pack.

Methods for controlling a power tool including a brushless motor and a battery pack interface. The battery pack interface is configured to receive a battery pack. The methods include determining a parameter associated with the battery pack, classifying the battery pack based on the determined parameter, and controlling field weakening applied to the brushless motor based on the classification of the battery pack.

In some aspects, the methods described herein further include applying, in response to classifying the battery pack as a high-capacity battery pack, field weakening to the brushless motor.

In some aspects, the methods described herein further include disabling, in response to classifying the battery pack as a low-capacity battery pack, field weakening to the brushless motor.

In some aspects, the methods described herein further include adjusting the field weakening applied to the brushless motor based the parameter associated with the battery pack.

In some aspects, the parameter is a state-of-charge of the battery pack, and the methods further include adjusting the field weakening applied to the brushless motor based on the state-of-charge of the battery pack.

In some aspects, the parameter is a temperature of the battery pack, and the method further includes adjusting the field weakening applied to the brushless motor based on the temperature of the battery pack.

In some aspects, the methods described herein further include receiving a first indication associated with a first operating mode of the power tool, the first operating mode including a first set of operating parameters that enable field weakening, controlling, in response to receiving the first indication associated with the first operating mode of the power tool, operation of the brushless motor according to the first operating mode, receiving a second indication associated with a second operating mode of the power tool, the second operating mode including a second set of operating parameters that disable field weakening, and controlling, in response to receiving the second indication associated with the second operating mode of the power tool, operation of the brushless motor according to the second operating mode.

In some aspects, the parameter associated with the battery pack is an identification of the battery pack.

In some aspects, the parameter associated with the battery pack is an impedance of the battery pack.

In some aspects, the parameter associated with the battery pack is an ampere-hour capacity of the battery pack.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

Other aspects of the embodiments will become apparent by consideration of the detailed description and accompanying drawings.

### BRIEF DESCRIPTION OF THE DRAWINGS

FIG. 1 illustrates a power tool, according to some embodiments.

FIG. 2 illustrates a partial cross-sectional view of the power tool of FIG. 1.

FIG. 3 illustrates a control system for the nailer of FIG. 1 implementing field weakening, according to some embodiments.

FIG. 4 illustrates a wireless communication controller for the power tool of FIG. 1, according to some embodiments.

FIG. 5 illustrates a communication system for the power tool of FIG. 1 and an external device, according to some embodiments.

FIG. 6 illustrates a user interface for the power tool of FIG. 1 and/or the external device of FIG. 5, according to some embodiments.

FIG. 7A is a schematic view of the power tool of FIG. 1 illustrating a driver blade in a driven or bottom-dead-center position.

FIG. 7B is a schematic view of the power tool of FIG. 1 illustrating a driver blade in an undriven or top-dead-center position prior to actuation.

FIG. 8A is an enlarged cross-sectional view of a portion of the power tool illustrating a passageway for supplementing pressure in the power tool.

FIG. 8B is an enlarged cross-sectional view of a portion of the nailer similar to FIG. 8A and illustrating a check valve positioned in the passageway.

FIG. 9 is a flow chart of a method for implementing field weakening in the power tool of FIG. 1, according to some embodiments.

FIG. 10 illustrates a block diagram of a power tool including sensored motor control, such as in the power tool of FIG. 1.

FIGS. 11A and 11B illustrate a sensor board of a brushless DC motor incorporated in the power tool of FIG. 1.

FIG. 11C is a graph showing commutation of a brushless motor, according to some embodiments.

FIG. 12 is a flow chart of a method for implementing sensored field weakening in the power tool of FIG. 1, according to some embodiments.

FIG. 13 is a block diagram for the control system of a sensorless field-oriented control (“FOC”) algorithm for use in the power tool of FIG. 1, according to some embodiments.

FIG. 14 is a graph illustrating a relationship between stator flux current and stator torque current, according to some embodiments.

FIG. 15 is a graph illustrating a negative stator flux current for use in sensorless field-oriented control (“FOC”) determined by a max-torque-per-amps (“MTPA”) algorithm, according to some embodiments.

FIG. 16 is a block diagram of a control system for implementing an MTPA algorithm, according to some embodiments.

FIG. 17 is a flow chart of a method for implementing an MTPA algorithm, according to some embodiments.

FIG. 18 is a graph illustrating a relationship between stator flux current and stator torque current, according to some embodiments.

FIG. 19 is a graph illustrating the results of a sensorless field weakening operation, according to some embodiments.

FIG. 20A is a block diagram of a control system for implementing a max-torque-per-volt (“MTPV”) algorithm, according to some embodiments.

FIG. 20B is a block diagram of a control system for implementing an MTPV algorithm, according to some embodiments.

FIG. 21 is a flow chart of a method for implementing an MTPV algorithm, according to some embodiments.

FIG. 22A is a flow chart of a method for implementing sensorless field weakening in the power tool of FIG. 1, according to some embodiments.

FIG. 22B is a graph illustrating the output of the power tool of FIG. 1 implementing the method of FIG. 22A, according to some embodiments.

FIG. 23 is a graph illustrating a relationship between motor speed, motor torque, stator flux current, and stator torque current, according to some embodiments.

FIG. 24 is a graph illustrating a relationship between motor speed, motor torque, stator current, and source current, according to some embodiments.

FIG. 25 is a graph illustrating a relationship between motor speed, motor torque, a stator flux current determined by an MTPA algorithm, and a stator flux current determined by an MTPV algorithm, according to some embodiments.

FIG. 26 is a graph illustrating a relationship between motor speed, motor torque, a correction factor used in an MTPV algorithm, and a modulation index used in an MTPV algorithm, according to some embodiments.

FIG. 27 is a graph illustrating a relationship between motor speed, motor torque, a stator torque current determined by an MTPA algorithm, and a stator torque current determined by an MTPV algorithm, according to some embodiments.

FIG. 28 is a graph illustrating relationships between motor torque and motor speed and motor torque and motor current, according to some embodiments.

FIG. 29 is a flow chart of a method for implementing sensorless field weakening in the power tool of FIG. 1, according to some embodiments.

FIG. 30A illustrates a battery pack, according to some embodiments.

FIG. 30B illustrates a group of battery cells, according to some embodiments.

FIG. 31A illustrates a battery pack, according to some embodiments.

FIG. 31B illustrates a group of battery cells, according to some embodiments.

FIG. 32 illustrates a circuit diagram for a switching module, according to embodiments described herein.

FIGS. 33A, 33B, 33C, and 33D illustrate circuit diagrams to demonstrate current flow in the circuit diagram of FIG. 32, according to some embodiments.

FIGS. 34A, 34B, and 34C are a flow chart of a method for determining an impedance of a battery pack, according to some embodiments.

FIG. 35 illustrates a circuit for determining an identity of a battery pack, according to some embodiments.

FIG. 36 is a flow chart of a method for controlling field weakening of the power tool of FIG. 1 using a classification of a battery pack, according to some embodiments.

FIG. 37 is a flow chart of a method for controlling operation of the power tool of FIG. 1, according to some embodiments.

FIG. 38 is a flow chart of a method for controlling operation of the power tool of FIG. 1 using a parameter of a battery pack, according to some embodiments.

FIG. 39 is a flow chart of a method for controlling operation of the power tool of FIG. 1 using a parameter of a battery pack, according to some embodiments.

### DETAILED DESCRIPTION

Embodiments described herein relate to a power tool, such as, for example, a fastener driver or nailer, that is configured to implement field weakening motor control to increase, for example, the speed of an operation of power tool. The field weakening can be accomplished using sensored or sensorless motor control. In some implementations, the field weakening is applied to the operation of the nailer to move a piston from a bottom-dead center position (e.g., after firing a nail) to a top-dead center position for the next operation. The field weakening increases the speed of the piston moving from the bottom-dead center position to the top-dead center position, thereby reducing the time required between operations.

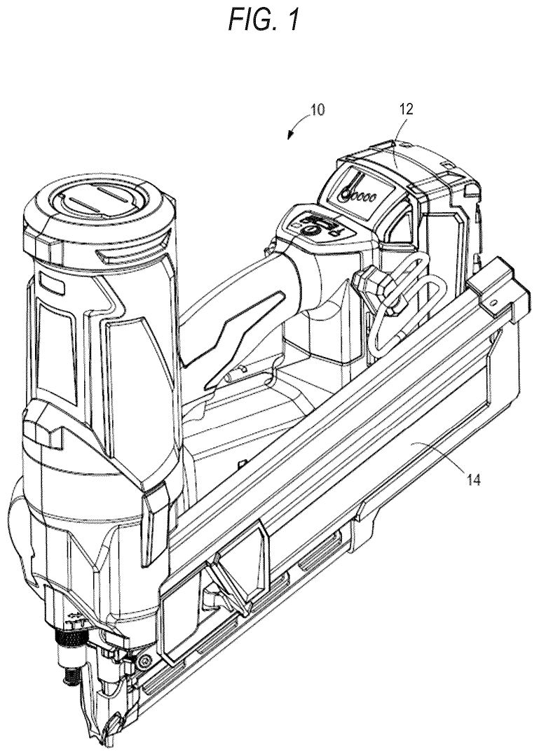

FIG. 1 illustrates a power tool 10, such as a fastener driver or nailer 10 (e.g., a gas spring-powered nailer), that is operable to drive fasteners (e.g., single-headed nails, double-headed or duplex nails, tacks, staples, etc.) held within a magazine 14 into a workpiece. The nailer 10 is powered by a removable and rechargeable battery pack 12. Although the methods and control techniques described herein are described in an exemplary manner primarily with respect to a nailer or other fastening device (e.g., a stapler), the methods and control techniques described herein can be implemented in other power tools 10. For example, the power tool 10 can be a circular saw, a jigsaw, a reciprocating saw, a bandsaw, a grinder, a cutoff saw, a tire buffer, a mud mixer, a bandfile, a polisher, a sander, a cutoff tool, a rotary hammer, a drill-driver, a hammer drill, a right angle drill, an impact driver, an impact wrench, a ratchet, a screwdriver, a crimper, a pipe threader, a pump, a cable cutter, a cable stripper, a rod cutter, a tube cutter, a pipe shear, a knockout tool, a PEX expander, an inflator, a compressor, a sewer drum, a transfer pump, a drain snake, a rivet tool, a heat gun, a grease gun, a caulk gun, a chain hoist, a track saw, a miter saw, a table saw, a multi-tool, a router, a planer, a vacuum, a fan, a blower, etc.

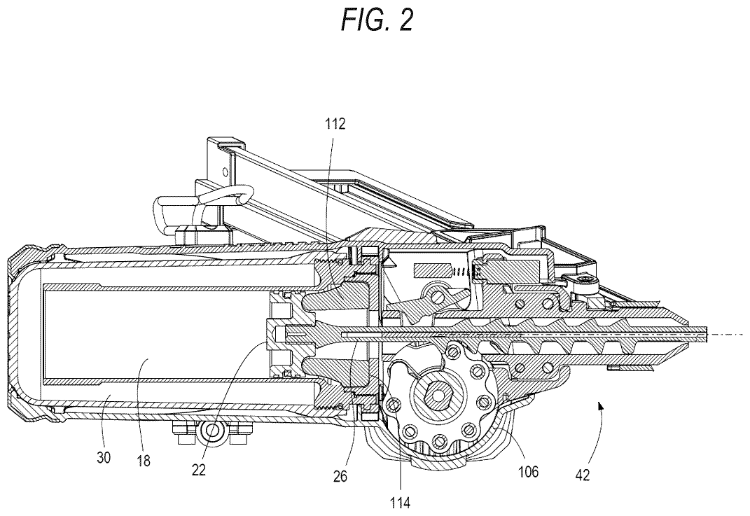

With reference to FIG. 2, the nailer 10 does not require an external source of air pressure, but rather includes an outer storage chamber cylinder 30 of pressurized gas in fluid communication with a cylinder 18. In the illustrated embodiment, the cylinder 18 and moveable piston 22 are positioned within the storage chamber cylinder 30. The nailer 10 includes a bumper 112 that is positioned beneath the piston 22 to stop the piston 22 at a driven position and to absorb the impact energy from the piston 22. The bumper 112 is configured to distribute the impact force of the piston 22 uniformly throughout the bumper 112 as the piston 22 is rapidly decelerated upon reaching a driven position (i.e., a bottom dead center position). The bumper 112 is disposed in the cylinder 18 and is clamped into place by a drive mechanism or a lifter housing portion 106, which is threaded to the bottom end of the cylinder 18. As shown, the bumper 112 is received within a cutout 114 that is formed in the lifter housing portion 106. The cutout 114 coaxially aligns the bumper 112 relative to a striker or driver blade 26. Although the term driver blade is used herein, the term striker can be interchangeably used in pace of driver blade. The driver blade 26 is configured to move with the piston 22 along the same path of motion (e.g., from top dead center to bottom dead center).

As shown in FIG. 2, the storage chamber cylinder 30 is concentric with the cylinder 18. The cylinder 18 has an annular inner wall that guides the piston 22 and the driver blade 26 along the driving axis 700 to compress the gas in the storage chamber cylinder 30. The storage chamber cylinder 30 has an annular outer wall circumferentially surrounding the inner wall. The cylinder 18 has a threaded section and the storage chamber cylinder 30 has corresponding threads at a lower end of the storage chamber cylinder 30 such that the cylinder 18 is threadably coupled to the storage chamber cylinder 30 at the lower end. As such, the cylinder 18 is configured to be axially secured to the storage chamber cylinder 30

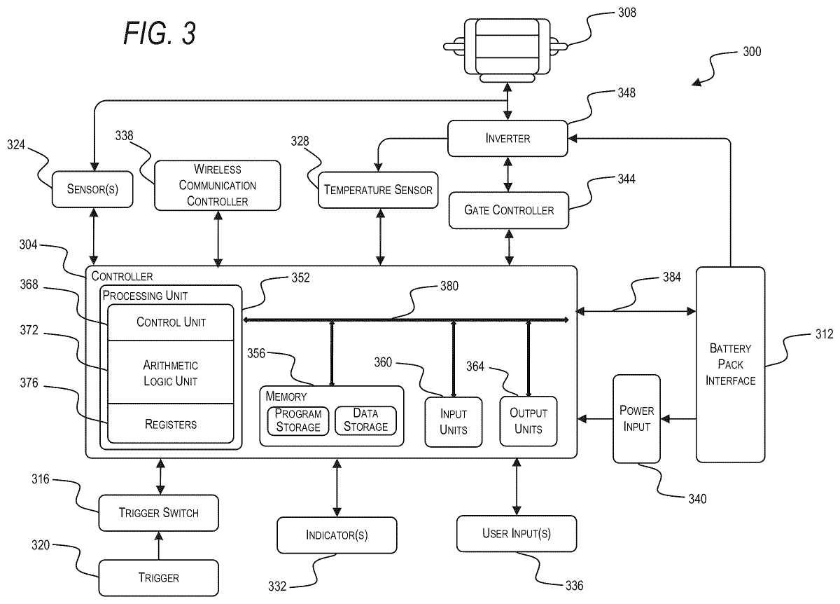

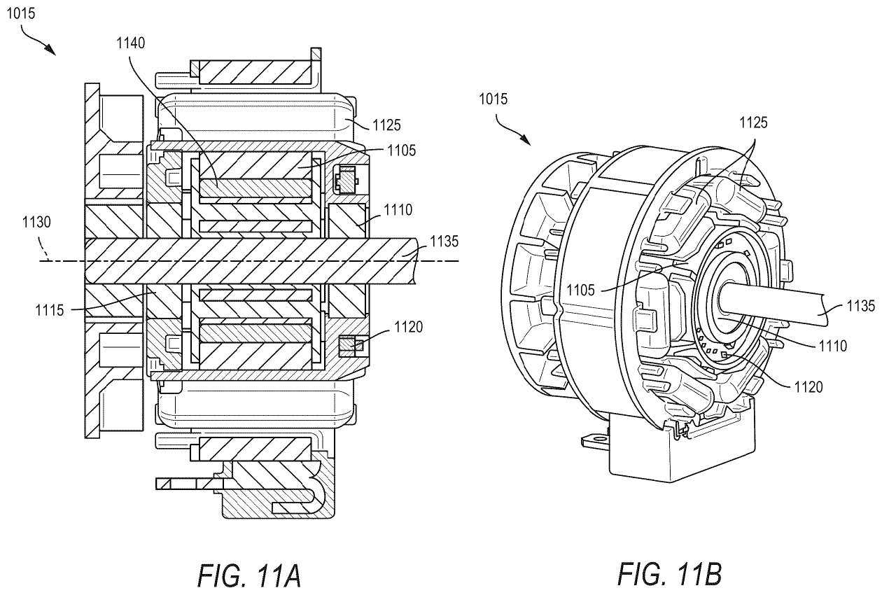

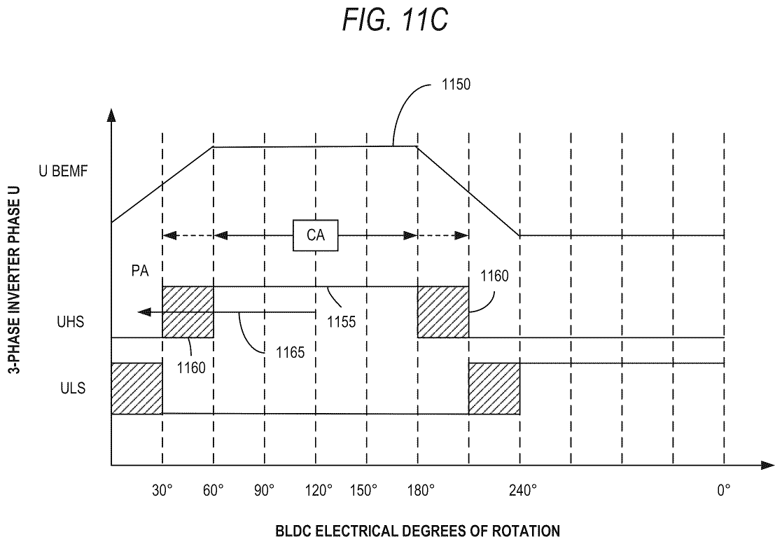

FIG. 3 illustrates a control system 300 for the nailer 10 implementing field weakening. The control system 300 includes a controller 304. The controller 304 is be electrically and/or communicatively connected to a variety of modules or components of the nailer. For example, the illustrated controller 304 is electrically connected to a motor 308 (e.g., see motor 1015 in FIGS. 11A and 11B), a battery pack interface 312, a trigger switch 316 (connected to a trigger 320), one or more sensors 324 (e.g., a current sensor, a position sensor, etc.) and a temperature sensor 328, a wireless communication controller 338, one or more indicators 332, one or more user input modules 336, a power input module 340, and a gate controller 344 (connected to an inverter 348). The motor 308 includes a rotor, a stator, and a shaft that rotates about a longitudinal axis.

The controller 304 includes combinations of hardware and software that are operable to, among other things, control the operation of the nailer 10, monitor the operation of the nailer 10, activate the one or more indicators 332 (e.g., an LED), etc. The gate controller 344 is configured to control the inverter 348 to convert a DC power supply to phase signals for powering the phases of the motor 308. The current sensor 324 is configured to, for example, sense a current between the inverter 348 and the motor 308. The temperature sensor 328 is configured to, for example, sense a temperature of the inverter 348. In some implementations, the temperature sensor 328 is configured to, for example, sense a temperature of the rechargeable battery pack 12.

The controller 304 includes a plurality of electrical and electronic components that provide power, operational control, and protection to the components and modules within the controller 304 and/or the nailer 10. For example, the controller 304 includes, among other things, a processing unit 352 (e.g., a microprocessor, a microcontroller, or another suitable programmable device), a memory 356, input units 360, and output units 364. The processing unit 352 includes, among other things, a control unit 368, an arithmetic logic unit (“ALU”) 372, and a plurality of registers 376 (shown as a group of registers in FIG. 3), and is implemented using a known computer architecture (e.g., a modified Harvard architecture, a von Neumann architecture, etc.). The processing unit 352, the memory 356, the input units 360, and the output units 364, as well as the various modules or circuits connected to the controller 304 are connected by one or more control and/or data buses (e.g., common bus 380). The control and/or data buses are shown generally in FIG. 3 for illustrative purposes. The use of one or more control and/or data buses for the interconnection between and communication among the various modules, circuits, and components would be known to a person skilled in the art in view of the invention described herein.

The memory 356 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 352 is connected to the memory 356 and executes software instructions that are capable of being stored in a RAM of the memory 356 (e.g., during execution), a ROM of the memory 356 (e.g., on a generally permanent basis), or another non-transitory computer readable medium such as another memory or a disc. Software included in the implementation of the nailer 10 can be stored in the memory 356 of the controller 304. The software includes, for example, firmware, one or more applications, program data, filters, rules, one or more program modules, and other executable instructions. The controller 304 is configured to retrieve from the memory 356 and execute, among other things, instructions related to the control processes and methods described herein. In other constructions, the controller 304 includes additional, fewer, or different components.

The battery pack interface 312 includes a combination of mechanical components (e.g., rails, grooves, latches, etc.) and electrical components (e.g., one or more terminals) configured to and operable for interfacing (e.g., mechanically, electrically, and communicatively connecting) the nailer 10 with a battery pack. For example, power provided by the battery pack to the nailer is provided through the battery pack interface 312 to the power input module 340. The power input module 340 includes combinations of active and passive components to regulate or control the power received from the battery pack prior to power being provided to the controller 304. The battery pack interface 312 also supplies power to the inverter 348 to be switched by the switching FETs to selectively provide power to the motor 308. The battery pack interface 312 also includes, for example, a communication line 384 to provide a communication line or link between the controller 304 and the battery pack.

The indicators 332 include, for example, one or more light-emitting diodes (“LEDs”). The indicators 332 can be configured to display conditions of, or information associated with, the nailer 10. For example, the indicators 332 are configured to indicate measured electrical characteristics of the nailer 10, the status of the device, etc. The one or more user input modules 336 may be operably coupled to the controller 304 to, for example, select a forward mode of operation or a reverse mode of operation, a torque and/or speed setting for the nailer 10 (e.g., using torque and/or speed switches), etc. In some embodiments, the one or more user input modules 336 may include a combination of digital and analog input or output devices required to achieve a desired level of operation for the nailer, such as one or more knobs, one or more dials, one or more switches, one or more buttons, etc. In some embodiments, the one or more user input modules 336 may receive signals wirelessly from a device external to the nailer 10 (e.g., a user's mobile phone).

The controller 304 may be configured to determine whether a fault condition of the nailer 10 is present and generate one or more control signals related to the fault condition. For example, the controller 304 may calculate or include, within memory 356, predetermined operational threshold values and limits for operation of the nailer 10. For example, when a potential thermal failure (e.g., of a FET, the motor 308, etc.) is detected or predicted by the controller 304, power to the motor 308 can be limited or interrupted until the potential for thermal failure is reduced. If the controller 304 detects one or more such fault conditions of the nailer or determines that a fault condition of the nailer 10 no longer exists, the controller 304 may be configured to provide information and/or control signals to another component of the nailer 10 (e.g., the battery pack interface 312, the indicators 332, etc.). The signals can be configured to, for example, trip or open a high impedance trace of the nailer, reset a switch, etc.

The controller 304 may be configured to determine a state-of-charge (“SOC”) the rechargeable battery pack 12. The controller 304 may also be configured to receive signals from a monitoring circuit (e.g., including sensors 324, etc.) that is configured to sense the SOC level, or voltage value, of battery cells of the rechargeable battery pack 12, and transmit the voltage readings to the controller 304. The voltage level of the battery cells may be determined by, for example, measuring the total open circuit voltage of the battery cells or by summing the voltage measurements of each battery cell. In some embodiments, the monitoring circuit is additionally configured to sense a discharge current of the battery cells (e.g., using a current sensor) and/or a temperature of the rechargeable battery pack 12 (e.g., using a temperature sensor) and transmit the sensed current and/or temperature readings to the controller 304. The monitoring circuit is further configured to receive commands from the controller 304 during operation of the nailer 10. In some embodiments, the SOC, a sensed current, and or a sensed temperature, of the rechargeable battery pack 12 is determined by the battery pack 12 and communicated to the power tool 10.

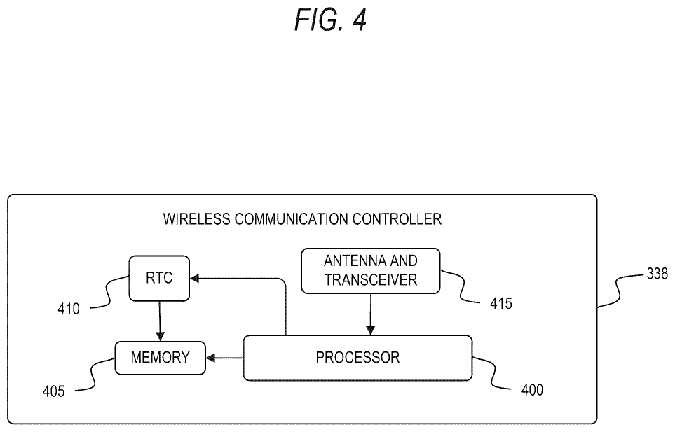

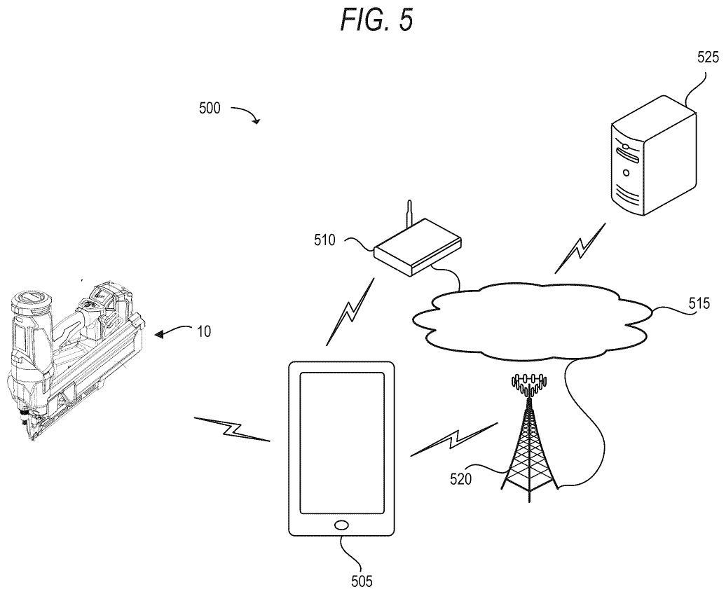

FIG. 4 provides an illustration of the wireless communication controller 338 that includes a processor 400, a memory 405, a real-time clock (“RTC”) 410, and an antenna and transceiver 415. The wireless communication controller 338 enables the nailer 10 to communicate with an external device 505 (see, e.g., FIG. 5). The radio antenna and transceiver 415 operate together to send and receive wireless messages to and from the external device 505 and the processor 400. The memory 405 can store instructions to be implemented by the processor 400 and/or may store data related to communications between the nailer 10 and the external device 505 or the like. The RTC 410 can increment and keep time independently of the other device components. The RTC 410 can receive power from the battery pack 12 when the battery pack 12 is connected to the nailer 10. The processor 400 for the wireless communication controller 338 controls wireless communications between the nailer 10 and the external device 505. For example, the processor 400 associated with the wireless communication controller 338 buffers incoming and/or outgoing data, communicates with the controller 304, and determines the communication protocol and/or settings to use in wireless communications. The communication via the wireless communication controller 338 can be encrypted to protect the data exchanged between the nailer 10 and the external device 505 from third parties.

In the illustrated embodiment, the wireless communication controller 338 is a Bluetooth® controller. The Bluetooth® controller communicates with the external device 505 employing the Bluetooth® protocol. Therefore, in the illustrated embodiment, the external device 505 and the nailer 10 are within a communication range (i.e., in proximity) of each other while they exchange data. In other embodiments, the wireless communication controller 338 communicates using other protocols (e.g., Wi-Fi, ZigBee, a proprietary protocol, etc.) over different types of wireless networks. For example, the wireless communication controller 338 may be configured to communicate via Wi-Fi through a wide area network such as the Internet or a local area network, or to communicate through a piconet (e.g., using infrared or NFC communications).

In some embodiments, the network is a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4GSM network, a 4G LTE network, 5G New Radio, a Digital Enhanced Cordless Telecommunications (“DECT”) network, a Digital AMPS (“IS-136/TDMA”) network, or an Integrated Digital Enhanced Network (“iDEN”) network, etc.

The wireless communication controller 338 is configured to receive data from the controller 304 and relay the information to the external device 505 via the antenna and transceiver 415. In a similar manner, the wireless communication controller 338 is configured to receive information (e.g., configuration and programming information) from the external device 505 via the antenna and transceiver 415 and relay the information to the controller 304.

FIG. 5 illustrates a communication system 500. The communication system 500 includes at least one power tool device (e.g., illustrated as the nailer 10) and the external device 505. The nailer 10 and the external device 505 can communicate wirelessly while they are within a communication range of each other. The nailer 10 may communicate a status, operation statistics, sensor data, stored usage information, and the like associated with the nailer 10. Although the nailer 10 is illustrated, any other type of power tool can be provided with the same or similar communications capabilities.

More specifically, the nailer 10 can monitor, log, and/or communicate various operational parameters. The external device 505 can also transmit data to the nailer 10 for operational configuration, firmware updates, or to send commands. The external device 505 also allows a user to set operational parameters, safety parameters, select tool modes, and the like for the nailer 10.

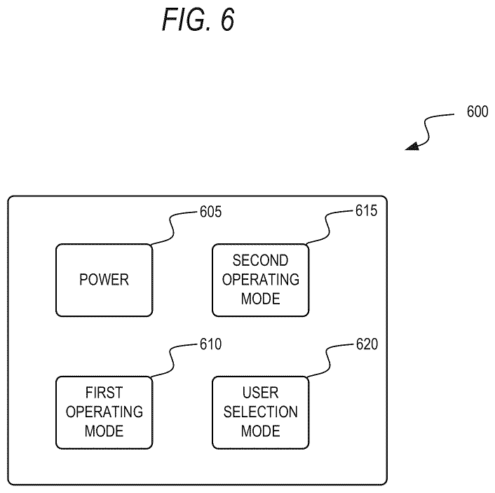

The external device 505 is, for example, a smart phone (as illustrated), a laptop computer, a tablet computer, a personal digital assistant (“PDA”), or another electronic device capable of communicating wirelessly with the nailer 10 and providing the user interface 600 (see, e.g., FIG. 6). The external device 505 provides the user interface 600 and allows a user to access and interact with the nailer 10. The external device 505 can receive user inputs to determine operational parameters, enable or disable features, and the like. The user interface 600 of the external device 505 provides an easy-to-use interface for the user to control and customize operation of the nailer 10 or a different type of power tool.

In addition, as shown in FIG. 5, the external device 505 can also share the operational data obtained from the nailer 10 with a remote server 525 connected through a network 515. The remote server 525 may be used to store the operational data obtained from the external device 505, provide additional functionality and services to the user, or a combination thereof. In some embodiments, storing the information on the remote server 525 allows a user to access the information from a plurality of different locations. In some embodiments, the remote server 525 collects information from various users regarding their power tool devices and provide statistics or statistical measures to the user based on information obtained from the different power tools. The network 515 may include various networking elements (routers 510, hubs, switches, cellular towers 520, wired connections, wireless connections, etc.) for connecting to, for example, the Internet, a cellular data network, a local network, or a combination thereof, as previously described. In some embodiments, the nailer 10 is configured to communicate directly with the remote server 525 through an additional wireless interface or with the same wireless interface that the nailer 10 uses to communicate with the external device 505.

FIG. 6 illustrates the user interface 600 for the nailer 10 or another type of power tool. In some embodiments, the user interface 600 is included in the external device 505. The user interface 600 includes a plurality of graphical user interface elements, such as, a power control input 605, a first operating mode input 610, a second operating mode input 615, and a user selection mode input 620. The power control input 605 is configured to enable a user to activate and deactivate (e.g., turn ON and OFF) the nailer 10 or another power tool. The first operating mode input 610 is configured to enable a user to control performance of the nailer 10 or another power tool according to a first set of operating parameters. For example, the first operating mode input 610 provides operating parameters to control field weakening of the nailer 10 or another power tool based on selection of the first operating mode input 610 and/or a determination of a characteristic of the battery pack 12. In some embodiments, the first operating mode input 610 is configured to control operation of the nailer 10 in a “high performance” or high-power mode of operation (e.g., at the expense of efficiency and/or runtime) where field weakening is enabled. The second operating mode input 615 is configured to control operation of the nailer 10 or another power tool in a “energy conserving” or low-power mode of operation where field weakening is disabled. In other embodiments, the second operating mode input 615 is configured to enable a user to control performance of the nailer 10 according to a second set of operating parameters. For example, the second operating mode input 615 provides operating parameters to reduce or stop/prevent field weakening of the nailer 10 or another power tool based on activation of the second operating mode input 615 and/or a determination of a characteristic of the battery pack 12. In some instances, the second operating mode input 615 reduces field weakening of the nailer 10 based on a determination that the characteristic of the battery pack 12, such as, for example, a state-of-charge (SOC) or temperature, has reached a set threshold. The user selection mode input 620 is configured to enable a user to control performance of the nailer 10 or another power tool according to a set of operating parameters provided by the user (e.g., gradually increase or decrease an amount of field weakening, etc.).

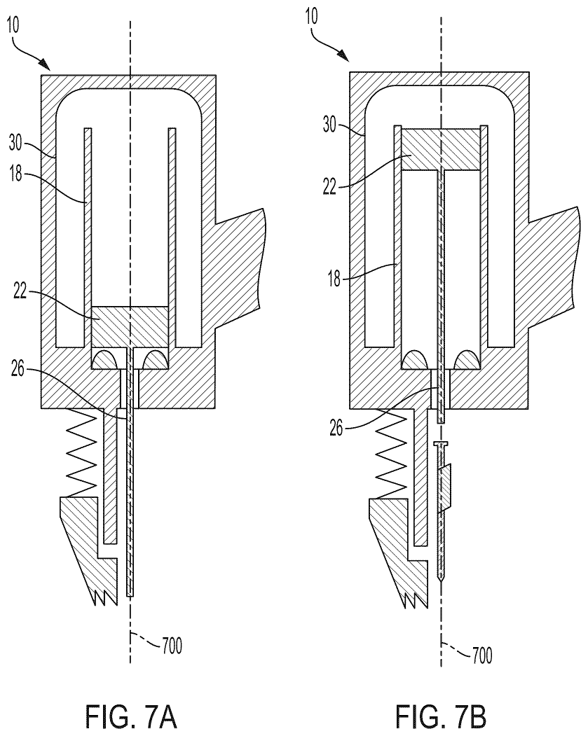

FIGS. 7A and 7B illustrate a partial section view of the nailer 10. As previously described with respect to FIG. 2, the nailer 10 includes the cylinder 18 and the piston 22 positioned within outer storage chamber cylinder 30. The piston 22 is configured to drive the driver blade 26. The nailer 10 does not require an external source of air pressure, and instead includes the outer storage chamber cylinder 30 of pressurized fluid (e.g., gas) in communication with the cylinder 18. The driver blade 26 defines a driving axis 700. During a driving cycle, the driver blade 26 and the piston 22 are moveable between a top-dead-center (“TDC”) position (as shown in FIG. 7B) and a driven or bottom-dead-center (“BDC”) position (as shown in FIG. 7A).

In operation, the lifter housing portion 106 drives the piston 22 and the driver blade 26 toward the TDC position by energizing the motor 308. As the piston 22 and the driver blade 26 are driven toward the TDC position, the gas above the piston 22 and the gas within the storage chamber cylinder 30 is compressed. Prior to reaching the TDC position, the motor 308 is deactivated and the piston 22 and the driver blade 26 are held in a ready position, which is located between the TDC and the BDC positions, until being released by user activation of the trigger 320. When released, the compressed gas above the piston 22 and within the storage chamber cylinder 30 drives the piston 22 and the driver blade 26 to the driven position, thereby driving a fastener into the workpiece. The illustrated nailer 10 therefore operates on a gas spring principle utilizing the lifter housing portion 106 and the piston 22 to further compress the gas within the cylinder 18 and the storage chamber cylinder 30.

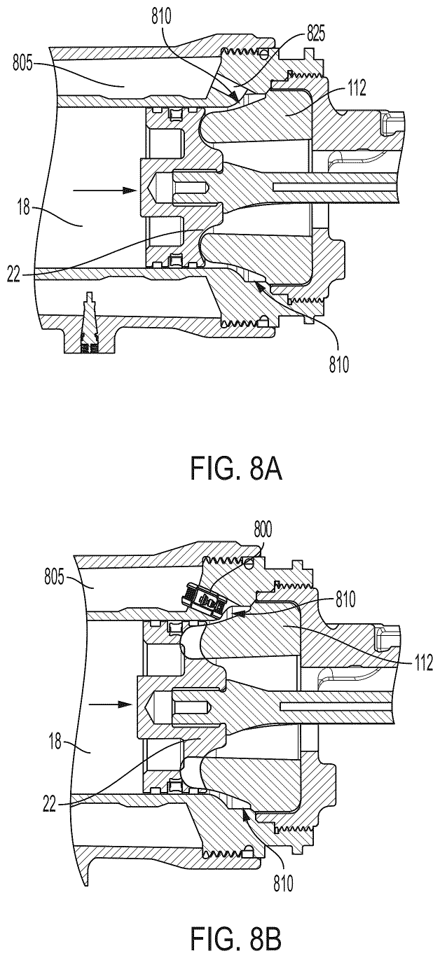

For example, with reference to FIGS. 8A and 8B, the nailer 10 includes a check valve 800 (or similar valve) that is positioned between the bumper 112 and the outer storage chamber cylinder 30 within a passageway 805. The check valve 800 is responsive to pressure as the piston 22 compresses the bumper 112. More specifically, as the piston 22 is driven from the ready position to the driven position, the piston 22 impacts the bumper 112, which seals against the inner cylinder 18 to create an air reservoir or intermediate chamber 810. The intermediate chamber 810 is formed between a bottom portion of the cylinder 18 and the bumper 112 (and in some circumstances, the bumper 112 and the piston 22) when the driver blade 26 approaches the BDC position. That is, the intermediate chamber 810 is completely sealed (i.e., not fluidly connected to the outside atmosphere) when the piston 22 impacts the bumper 112. As the piston 22 compresses the bumper 112, the pressure in the intermediate chamber 810 increases and opens the check valve 800. This increased air pressure through the opened check valve 800 adds a small amount of pressurized air to the outer storage chamber cylinder 30, which results in a higher pressure applied to the cylinder 18 that can compensate for potential or actual air pressure losses in the nailer 10. As such, an increase in air pressure can be generated using bumper compression that occurs at the end of every firing event of the nailer 10. This avoids the need for a separate compressor to be attached to the cylinder 18 for increasing the pressure on the piston 22. In effect, the complementary compression of the bumper 112 and the opening of the check valve 800 forms an onboard air compressor for the nailer 10.

By using the repetitive compression of the bumper 112 by the piston 22 to complement the pressure in the storage chamber cylinder 30, a small amount of air pressure (e.g., approximately 0.01-0.015 psi) can be added each time the bumper 112 is compressed by the piston 22. Extrapolating this over 1000 nails fired by the nailer 10, this added pressure equates to approximately 10-15 psi, which is 10-15% of the total tank pressure. While the added pressure is relatively small compared to the total tank pressure, the added pressure facilitated by compression of the bumper 112 and the opened check valve 800 is enough to maintain an adequate tank pressure even after pressure losses are accounted for (e.g., due to permeation, minor debris ingress, or mild mechanical wear).

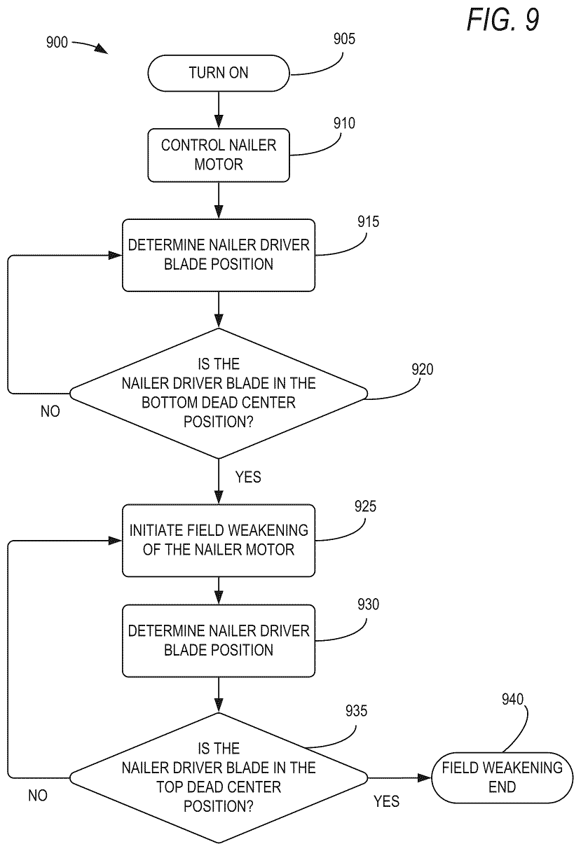

FIG. 9 is a flow chart of a method 900 for implementing field weakening control of the nailer 10. The method 900 begins when the nailer 10 is turned on (BLOCK 905). The controller 304 is configured to execute the method 900 and begins control of the motor 308 based on receiving power (BLOCK 910). The controller 304 determines the nailer driver blade 26 position (BLOCK 915) based on, for example, a sensed position of the driver blade 26 (e.g., based on motor rotational position, a sensor that directly detects the position of the driver blade 26, etc.). If the driver blade 26 position is determined to be in the BDC position (BLOCK 920), the controller 304 initiates a field weakening command for the motor 308 (BLOCK 925). If the driver blade 26 is not determined to be in the BDC position, the method 900 returns to BLOCK 915 to determine the driver blade 26 position. Once field weakening is initiated at BLOCK 925, the controller 304 determines the driver blade 26 position again (BLOCK 930). If the driver blade 26 is determined to be in the TDC position (BLOCK 935), the controller 304 generates a command to end field weakening of the motor 308 (BLOCK 940). If the driver blade 26 is not determined to be in the TDC position, the method 900 returns to BLOCK 925 to continue field weakening of the motor 308. In some embodiments, the controller 304 can initiate different field weakening techniques for the motor 308 at BLOCK 925. For example, the controller 304 can initiate the field weakening based on a sensed voltage (e.g., voltage sag) of the battery pack 12, a remaining capacity or state of charge of the battery pack 12, etc. In some embodiments, the controller 304 can initiate the field weakening based on a sensed current of the motor 308 provided by the current sensor 324. In some embodiments, the controller 304 can initiate the field weakening command based on a sensed current of the battery pack 12. In some embodiments, the controller 304 can initiate the field weakening based on a sensed temperature of the battery pack 12.

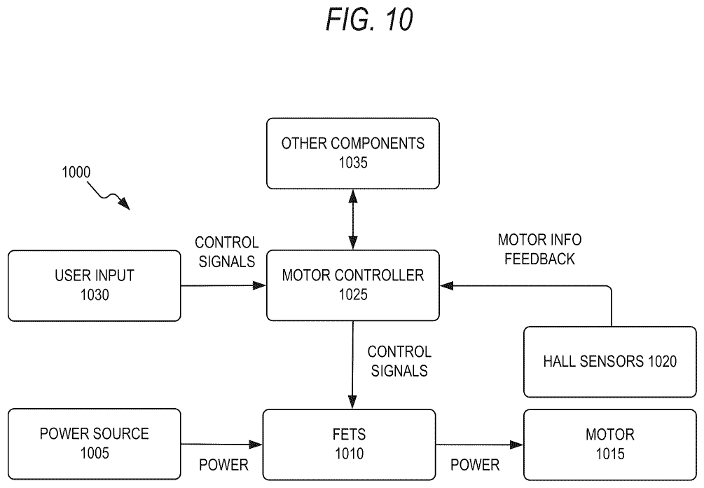

FIG. 10 illustrates a simplified block diagram of an embodiment 1000 of the nailer 10 that implements sensored motor control for implementing the field weakening of the method 900. The nailer 1000 includes a power source 1005, switches or Field Effect Transistors (“FETs”) 1010, a motor 1015, Hall effect sensors 1020, a motor controller 1025 (e.g., controller 304), user input 1030, and other components 1035 (e.g., a battery pack fuel gauge, work lights (LEDs), current/voltage sensors, etc.). The power source 1005 provides DC power to the various components of the nailer 1000 and may be a power tool battery pack that is rechargeable and uses, for instance, lithium-ion cell technology (e.g., battery pack 12). In some instances, the power source 1005 may receive AC power (e.g., 120V/60 Hz) from a tool plug that is coupled to a standard wall outlet, and then filter, condition, and rectify the received power to output DC power. Each Hall effect sensor 1020 outputs motor feedback information, such as an indication (e.g., a pulse) when a magnet of the rotor rotates across the face of that Hall effect sensor 1020. Based on the motor feedback information from the Hall effect sensors 1020, the motor controller 1025 can determine the position, velocity, and/or acceleration of a rotor of the motor 1015. The motor controller 1025 also receives user controls from user input 1030, such as by depressing the trigger 320. In response to the motor feedback information and user controls, the motor controller 1025 transmits control signals to control the FETs 1010 to drive the motor 1015. By selectively enabling and disabling the FETs 1010, power from the power source 1005 is selectively applied to stator coils of the motor 1015 to cause rotation of the rotor. Although not shown, the motor controller 1025 and other components of the nailer 1000 are electrically coupled to the power source 705 such that the power source 1005 provides power thereto.

FIGS. 11A and 11B illustrates the motor 1015 in the nailer 1000. The motor 1015 includes a rotor 1105, a front bearing 1110, a rear bearing 1115 (collectively referred to as the bearings 1110, 1115), a position sensor board assembly 1120 within a stator envelope of the motor 1015, and a motor shaft 1135. Stator coils 1125 are parallel to the length of a rotor axis 1130. Rotor magnets 1140 are brought into proximity of the Hall effect sensors 1020 on the position sensor board assembly 1120 in order to detect the rotor position. Recessing the rotor 1105, the bearings 1110, 1115, and the position sensor board assembly 1120 within the stator envelope allows a more compact motor 1015 in the axial direction.

FIG. 11C is a graph 1150 illustrating commutation applied to the motor 308 in the nailer 10. In some embodiments, the conduction angle of the motor 308 may be varied to increase the conduction angle. Generally, a conduction angle applied to a BLDC motor (e.g., the motor 308, 1015) is set to a default value (e.g., approximately 105°, approximately 120°, between 90° and 120°, etc.). However, in order to increase speed, such as via field weakening, the conduction angle for a given phase may be increased up to a maximum value, such as 180°. As shown in FIG. 11C, the conduction angle may generally be 120° and applied to either a high side switch (such as high side FETs) or low side switches (such as low side FETs) as described above, in order to drive a motor 308, 1015. As further shown in FIG. 11C, the conduction angle 1155 may be increased (as shown by optional conduction regions 1160) from 120° to a maximum value, such as 180°. Further, as noted above, the conduction angle 1155 may be shifted to occur earlier in the conduction cycle (i.e., phase advance), as shown by phase advance line 1165. In some embodiments, the controller 304 may use a single or combination of field weakening methodologies of this disclosure to control the motor 308, 1015 of a power tool.

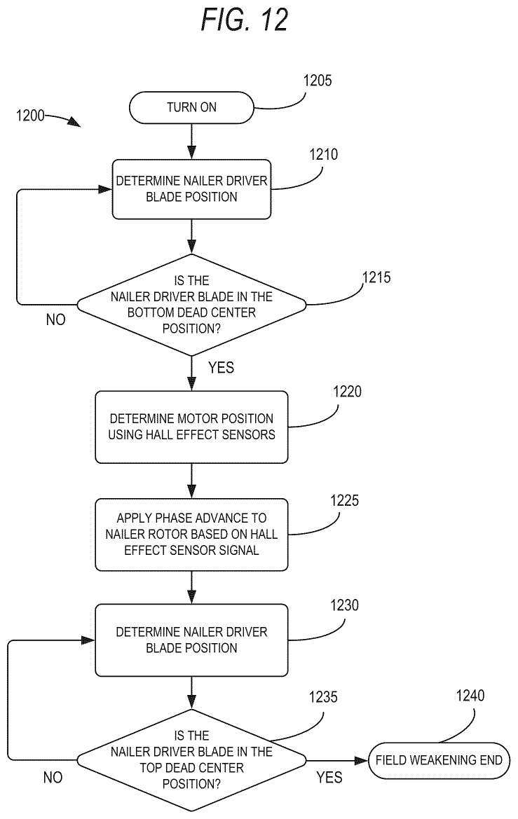

FIG. 12 is a flow chart of a method 1200 for implementing sensored field weakening control of the nailer 10, 1000. The method 1200 begins when the nailer 10, 1000 is turned on and the controller 1025 is configured to execute the method 1200 and begins control of the motor 1015 based on receiving power (BLOCK 1205). The controller 1025 determines the nailer driver blade 26 position (BLOCK 1210) based, for example, a sensed position of the driver blade 26 (e.g., based on motor rotational position, a sensor that directly detects the position of the driver blade 26, etc.). If the driver blade 26 position is determined to be in the BDC position (BLOCK 1215), the controller 1025 determines the position of the motor 1015 based on input signals from the Hall effect sensors 1020 (BLOCK 1220). If the driver blade 26 is not determined to be in the BDC position, the method 1200 returns to BLOCK 1210 to determine driver blade 26 position. Once motor 1015 position is determined (BLOCK 1220), the controller 1025 generates a command to apply a phase advance angle to initiate field weakening of the motor 1015 (BLOCK 1225). The controller 1025 determines the driver blade 26 position again (BLOCK 1230). If the driver blade 26 is determined to be in the TDC position (BLOCK 1235), the controller 1025 generates a command to end field weakening of the motor 1015 (BLOCK 1240) by removing the phase advance angle command. If the driver blade 26 is not determined to be in the TDC position, the method 1200 returns to BLOCK 1230 to continue field weakening of the motor 1015.

In some embodiments, the controller 1025 can initiate different field weakening techniques for the motor 1015 at BLOCK 1225. For example, the controller 304 can initiate the field weakening based on a sensed voltage (e.g., voltage sag) of the battery pack 12, a remaining capacity or state of charge of the battery pack 12, etc. In some embodiments, the controller 304 can initiate the field weakening based on a sensed current of the motor 1025 provided by the current sensor 324. In some embodiments, the controller 304 can initiate the field weakening command based on a sensed current of the battery pack 12. In some embodiments, the controller 304 can initiate the field weakening based on a sensed temperature of the battery pack 12.

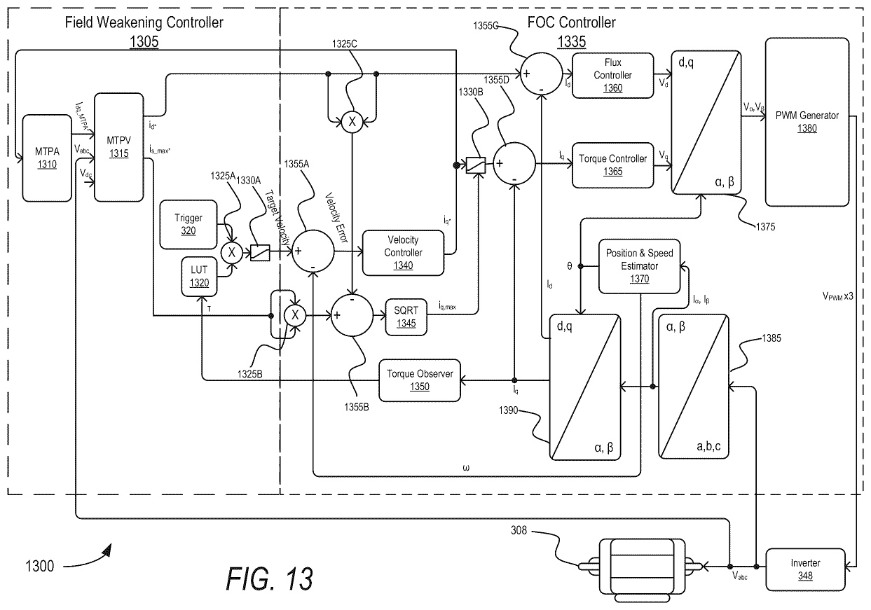

FIG. 13 is a block diagram for a control system 1300 of a sensorless field weakening algorithm for use in the nailer 10. The control system 1300 can be implemented by the controller 304 and can include one or more additional controllers (e.g., dedicated controllers). For example, as illustrated by FIG. 13, the control system 1300 includes a field weakening controller 1305 and a sensorless or field-oriented control (“FOC”) controller 1335. The field weakening controller 1305 and the FOC controller 1335 may include one or more mathematical operator blocks, such as multiplication blocks 1325A-C which multiply two or more input values, linear scaling blocks 1330A-B which linearly scale an input value based on a scaling factor, square root blocks 1345 which determine the square root of an input value, and/or addition/subtraction blocks 1355A-D which add or subtract two or more input values. In some embodiments the mathematical operator blocks may perform different mathematical operations. For example, the linear scaling blocks 1330A-B may scale a value up or down based on a non-linear function. The field weakening controller 1305 and the FOC controller 1335 may each include one or more components that are configured to send and receive signals between the field weakening controller 1305 and the FOC controller 1335. In some embodiments, a sensorless motor control technique other than FOC is implemented.

The field weakening controller 1305 includes a control block for controlling a max-torque-per-amps (“MTPA”) algorithm (“MTPA block 1310”) and a control block for controlling a max-torque-per-volts (“MTPV”) algorithm (“MTPV block 1315”). The MTPA block 1310 receives one or more inputs, such as an input i_{q}* from the FOC controller 1335 relating to a torque current. The MTPA block 1310 may perform one or more mathematical operations to generate and output a signal I_{dq_MTPA}* relating to a flux current and a torque current. The MTPV block 1315 receives one or more signals, such as an input I_{dq_MTPA}* from the MTPA block 1310 relating to a flux current and a torque current, an input V_{abc} relating to voltages applied to the phases of the sensorless motor 308, and/or an input V_{dc} relating to a voltage of a battery pack connected to the nailer 10. The MTPV block 1315 may further generate one or more output signals, such as a signal i_{d}* relating to a flux current determined by the MTPV block 1315 and/or a signal i_{s_max}* relating to a maximum current of a stator of the motor 308 determined by the MTPV block 1315.

The field weakening controller 1305 may further include a look-up table (“LUT”) 1320 which contains one or more output values based on one or more input values. For example, the LUT 1320 may receive a signal t relating to a present torque of the motor 308. The LUT 1320 may determine and output a signal based on the received torque signal t. In some embodiments, the LUT 1320 is a speed map. The speed map receives an estimated load torque as an input, and outputs a speed reference value based on the estimated load torque. The speed map may be modifiable by a user to create tool-specific speed-torque characteristics. The field weakening controller 1305 may further include a first multiplication block 1325A which receives a first signal from the LUT 1320 and a second signal from the trigger 320 of the nailer 10, and multiplies the first and second signals to generate an output signal. The field weakening controller may further include a first linear scaling block 1330A which receives a signal from the first multiplication block 1325A and scales the signal based on a linear function, and outputs a signal corresponding to the result of the scaling. In some embodiments, the function is non-linear. The signal output by the first linear scaling block 1330A may be a target velocity for the motor 308.

The FOC controller 1335 includes a first addition/subtraction block 1355A configured to add a first signal received from the first linear scaling block 1330A corresponding to a target velocity for the motor 308 and to subtract a second signal @ corresponding to a present velocity of the motor 308. The first addition/subtraction block 1355A may be further configured to output a signal corresponding to the result of the first addition/subtraction block 1355A. The signal output by the first addition/subtraction block 1355A may be a velocity error of the motor 308. The FOC controller 1335 may further include a velocity controller 1340 configured to receive a signal from the first addition/subtraction block 1355A corresponding to a velocity error of the motor 308. The velocity controller 1340 may generate an output signal i*_{q} based on the velocity error and output the output signal i_{q}* to the MTPA block 1310.

The FOC controller 1335 may further include a second multiplication block 1325B configured to receive two signals i_{s_max} (i.e., the same signal twice) from the MTPV block 1315 of the field weakening controller 1305. The second multiplication block 1325B may multiply the two signals i_{s_max}* together to generate a squared value of i_{s_max}* and generate an output signal corresponding to the squared value of i_{s_max}. The FOC controller 1335 may further include a third multiplication block 1325C configured to receive two signals i_{d} (i.e., the same signal twice) from the MTPV block 1315 of the field weakening controller 1305. The third multiplication block 1325C may multiply the two signals i_{d}* together to generate a squared value of i_{d}*, and generate an output signal corresponding to the squared value of i_{d}. The FOC controller 1335 may further include a second addition/subtraction block 1355B configured to receive and add a first signal from the second multiplication block 1325B corresponding to the squared value of i_{s_max}*. The second addition/subtraction block 1355B may be further configured to receive and subtract a second signal from the third multiplication block 1325C corresponding to the squared value of i_{d}*. The second addition/subtraction block 1055B may be further configured to generate an output signal corresponding to the result of the second addition/subtraction block 1355B. The FOC controller 1335 may further include a square root block 1345 configured to receive a signal from the second addition/subtraction block 1355B corresponding to a result of the second addition/subtraction block 1355B. The square root block 1345 may be further configured to generate and output a signal i_{q,max} corresponding a to a square root value of the signal received from the second addition/subtraction block 1355B. That is to say, the combination of the second multiplication block 1325B, the third multiplication block 1325C, the second addition/subtraction block 1055B, and the square root block 1345 may be configured to perform a Pythagorean operation on the outputs of the MTPV block 1315 to break the current Iₛ of the stator of the motor 308 into its component vectors, the flux current i_{d} and the torque current i_{q}.

The FOC controller 1335 may further include a third addition/subtraction block 1355C configured to receive and add a first signal i_{d}* from the MTPV block 1315 corresponding to the flux current determined by the MTPV block 1315. The third addition/subtraction block 1355C may be further configured to receive and subtract a second signal I_{d} corresponding to a total flux current of the motor 308. The third addition/subtraction block 1355C may be configured to output a signal I_{d} corresponding to the result of the third addition/subtraction block 1355C. The FOC controller 1335 may further include a flux controller 1360 configured to receive an input signal I_{d} from the third addition/subtraction block 1355C and generate and output a flux voltage signal V_{d} based on the input signal I_{d}.

The FOC controller 1335 further includes a second linear scaling block 1330B configured to receive a first signal i_{q}* from the velocity controller 1340 and a second signal i_{q,max} from the square root block 1345. The second linear scaling block 1330B may be further configured to linearly scale the first signal i_{q}* based on the second signal i_{q,max} and output a signal corresponding to the result of the second linear scaling block 1330B. The FOC controller 1335 further includes a fourth addition/subtraction block 1355D configured to receive and add a first signal corresponding to the result of the second linear scaling block 1330B. The fourth addition/subtraction block 1355D may be further configured to receive and subtract a second signal I_{q} corresponding to a total torque current of the motor 308. The fourth addition/subtraction block 1355D may be configured to output a signal I_{q} corresponding to the result of the fourth addition/subtraction block 1355D. The FOC controller 1335 may further include a torque controller 1365 configured to receive an input signal I_{q} from the fourth addition/subtraction block 1355D and generate and output a torque voltage signal V_{q} based on the input signal I_{q}.

The FOC controller 1335 may further include an inverse Park transform block 1375 configured to receive a first signal V_{d} from the flux controller corresponding to a flux voltage, a second signal V_{q} from the torque controller corresponding to a torque voltage, and a third signal θ corresponding to a present angular position of a rotor of the motor 308. The inverse Park transform block 1375 may be configured to convert the first signal V_{d} and second signal V_{q} to orthogonal stationary reference frame quantities V_{α} and V_{β} based on the third signal θ. The inverse Park transform block 1375 may be further configured to output a signal corresponding to the orthogonal stationary reference frame quantities V_{α} and V_{β}. The FOC controller 1335 may further include a PWM generator 1380 including an inverse Clarke transform block, a PWM modulator, or both. The PWM generator 1380 may be configured to receive the signal corresponding to the orthogonal stationary reference frame quantities V_{d} and V_{β} from the inverse Park transform block 1375 and generate a plurality of pulse-width modulated (“PWM”) control signals V_{PWMX}3 configured to control the inverter 348. The inverter 348 may be configured to receive the plurality of PWM control signals V_{PWMX}3 and convert a DC power supply to a three-phase signal V_{abc} for controlling the motor 308. The three-phase signal V_{abc} may also be received by the MTPV block 1315.

The FOC controller 1335 further includes a three-phase-to-two-phase reference frame converter 1385 configured to receive the three-phase signal V_{abc} from the inverter and generate and output a two-phase current signal I_{α}, I_{β} based on the three-phase signal V_{abc}. The FOC controller 1335 furthers include a position and speed estimator 1370 configured to receive the two-phase current signal I_{α}, I_{β} from the three-phase-to-two-phase reference frame converter 1085 and estimate a position and speed of the sensorless motor 308 based on the two-phase current signal I_{α}, I_{β}. The position and speed estimator 1370 may be further configured to output a first signal θ relating to the current angular position of the rotor of the motor 308 and a second signal @ relating to the present rotational speed of the rotor of the motor 308. The first signal θ is received by the inverse Park transform block 1375. The second signal w is also received by the first addition/subtraction block 1355A. The FOC controller 1335 further includes a Park transform block 1390 configured to receive the two-phase current signal I_{α}, I_{β} from the three-phase-to-two-phase reference frame converter 1385 and the first signal θ relating to the present angular position of the rotor of the motor 308 from the position and speed estimator 1370. The Park transform block 1390 is further configured to generate a first signal I_{q} corresponding to a total torque current of the motor 308 and a second signal I_{α} corresponding to a total flux current of the motor 308 based on the two-phase current signal I_{α}, I_{β} and the first signal θ. The first signal I_{q} may be received by the torque observer 1350 and the fourth addition/subtraction block 1355D. The second signal I_{d} may be received by the third addition/subtraction block 1355C.

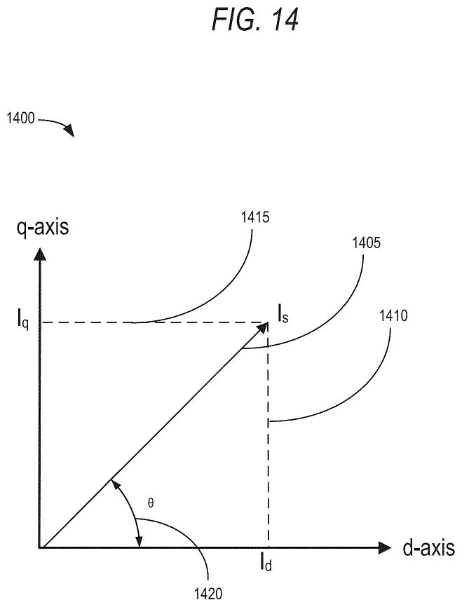

FIG. 14 is a graph 1400 illustrating a relationship between stator flux current and stator torque current on a q-d coordinate plane. The graph 1400 illustrates that the stator flux current i_{d} 1410 and the stator torque current i_{q} 1415 are both component vectors of the stator current Iₛ 1405. In particular, as illustrated by the graph 1400, i_{d} 1410 can be calculated as a function of Iₛ 1405 and the angle between Iₛ 1405 and the d-axis, θ 1420, by equation (1).

$${i}_{d} = {I}_{s} cos θ \qquad ( 1 )$$

Similarly, as illustrated by the graph 1100, i_{q} 1415 can be calculated as a function of Iₛ 1405 and θ 1420 by equation (2).

$${i}_{q} = {I}_{s} sin θ \qquad ( 2 )$$

A sensorless motor (for example, the motor 308 of FIG. 3), includes a rotor with a permanent magnet. This permanent magnet generates magnetic saliency, which in turn produces a reluctance torque from the difference between an inductance on the d-axis and an inductance on the q-axis. The reluctance torque, Tₑ, can be determined by equation (3), where P is the number of pole pairs of the motor, or is the stator flux, L_{d} is a direct inductance on the d-axis, and L_{q} is a quadrature inductance on the q-axis.

$${T}_{e} = 1.5 P ( {φ}_{f} {i}_{q} + ( {L}_{d} - {L}_{q} ) {i}_{d} {i}_{q} ) \qquad ( 3 )$$

Based on equation (3), it can be noted that a negative value of i_{d} 1410 will ensure that Tₑ remains positive, which is favorable. Furthermore, the above equations (1), (2), and (3) can be combined to create equation (4).

$${T}_{e} = 1.5 P ( {Φ}_{f} {I}_{s} sin θ + 0.5 ( {L}_{d} - {L}_{q} ) {I}_{s}^{2} sin 2 θ ) \qquad ( 4 )$$

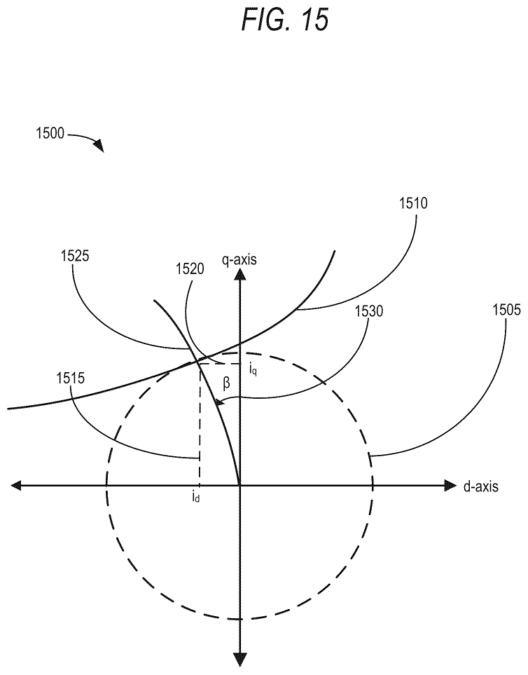

FIG. 15 is a graph 1500 illustrating a negative stator flux current for use in sensorless field weakening determined by a max-torque-per-amps (“MTPA”) algorithm. In particular, the graph 1500 illustrates an MTPA vector 1525 generated by an MTPA block (for example, MTPA block 1310) based on a crossing between of a constant current 1505 and a constant torque 1510 of the motor 308. In some embodiments, the MTPA vector 1525 is a minimum current space vector that satisfies at least one constraint of the MTPA algorithm. The MTPA vector 1525 further includes a beta-angle 1530. In some embodiments, the beta-angle 1530 is optimized between 0° and 45° from the q-axis. In some embodiments, the beta-angle 1530 being between 0° and 45° is a constraint of the MTPA algorithm. The point at which the MTPA vector 1525 crosses the constant current 1505 and the constant torque 1510 can be defined by a flux current i_{d} 1515 and a torque current i_{q} 1520. As can be seen by FIG. 15, at the point where the MTPA vector 1525 is optimized, the flux current i_{d} 1515 is negative in terms of the d-axis. In some embodiments, the MTPA vector 1525 may be at a different beta-angle 1530 while still satisfying being between 0° and 45° from the q-axis. However, in these embodiments, the MTPA vector 1525 may not be a minimum current space vector, and therefore not optimized.

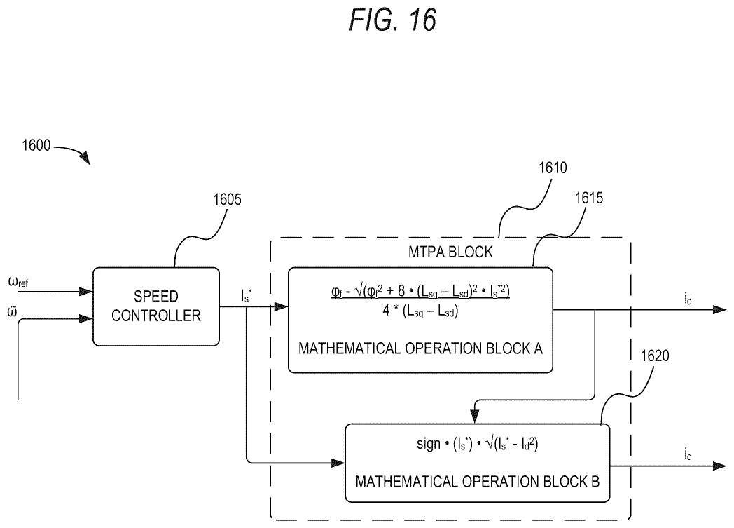

FIG. 16 is a block diagram of a control system 1600 for an MTPA algorithm. The control system 1600 includes a speed controller 1605 configured to receive a first signal ω_{ref} corresponding to a present angular speed of the rotor of the motor 308 and a second signal \tilde{ω} corresponding to a target angular speed for the rotor, and generate a stator current signal Iₛ* to control the stator based on the present angular speed ω_{ref} in reference to the target angular speed \tilde{ω}. The control system 1600 may further include an MTPA block 1610 including a first mathematical operation block 1615 and a second mathematical operation block 1620. The first mathematical operation block 1615 is configured to receive the stator current signal Iₛ* and generate a flux current signal i_{d}. The second mathematical operation block 1620 is configured to receive the stator current signal Iₛ* and the flux current signal i_{d} and generate a torque current signal i_{q}. The MTPA block 1610 is configured to generate a flux current signal i_{d} and a torque current signal i_{q} that, for example, satisfies the constraints identified with respect to FIG. 12 that the beta angle be between 0° and 45° from the q-axis and the MPTA vector (i.e., the vector created by the component i_{d} and i_{q} vectors) be a minimum current space vector. The values for i_{d} and i_{q} that satisfy these constraints can be determined by equations (5), (6), and (7).

$${i}_{d} = \frac{{Φ}_{f} - \sqrt{{Φ}_{f}^{2} + 8 {( {L}_{q} - {L}_{d} )}^{2} {I}_{s}^{2}}}{4 ( {L}_{q} - {L}_{d} )} \qquad ( 5 )$$

$${i}_{q} = sign ( {I}_{s} ) \sqrt{{I}_{s}^{2} - {i}_{d}^{2}} \qquad ( 6 )$$

$$sign ( {I}_{s} ) = 1 if {I}_{s} \geq 0 , \qquad ( 7 )$$

$$sign ( {I}_{s} ) = - 1 if {I}_{s} \leq 0$$

The first mathematical operation block 1615 is configured to generate the flux current signal i_{d} based on equation (5). The second mathematical operation block 1620 is configured to generate the torque current signal i_{q} based on equations (6) and (7).

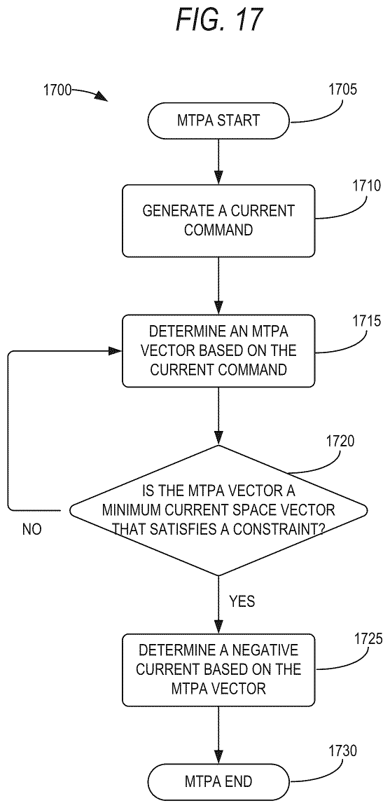

FIG. 17 is a flow chart of a method 1700 for implementing an MTPA algorithm. The method 1700 begins with the controller 304 executing the method 1700 and receiving a command to begin the MTPA algorithm (BLOCK 1705). The method 1700 includes generating a current command (BLOCK 1710). The current command may be generated by a speed controller (for example, speed controller 1605) based on a current angular speed ω_{ref} of the rotor of the motor 308 and a target angular speed @ for the rotor. The method 1700 also includes determining an MTPA vector (for example, the MTPA vector 1225) based on the current command (BLOCK 1715). The MTPA vector may be generated by an MTPA block (for example, MTPA block 1610) based on equation (5). The MTPA vector includes a torque current component, i_{q}, and a flux current component, i_{d}. The method 1700 also includes determining if the MTPA vector is a minimum current space vector that satisfies one or more constraints (BLOCK 1720). The one or more constraints may be one or more of the constraints identified with respect to FIG. 15, for example that the angle between the q-axis and the MTPA vector is between 0° and 45°

If the MTPA vector is not a minimum current space vector that satisfies the one or more constraints, the method 1700 returns to BLOCK 1715 and recalculates the MTPA vector. Returning to BLOCK 1720, if the MTPA vector is a minimum current space vector that satisfies the one or more constraints, the method 1700 includes determining a negative current based on the MTPA vector (BLOCK 1725). The negative current may be a stator flux current component of the MTPA vector, that is, i_{d}. Once the negative current has been identified, the MTPA algorithm has been completed and the method 1700 ends (BLOCK 1730).

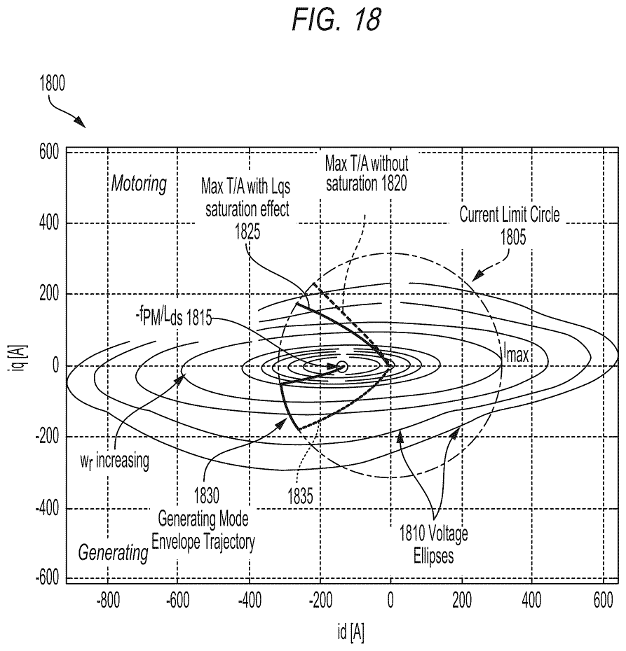

FIG. 18 is a graph 1800 illustrating a relationship between stator flux current and stator torque current. The graph 1800 includes a current limit 1805 as a circle with an amplitude centered at the origin, and a voltage limit 1810 as a family of nested ellipses centered at the point at which the MTPA vector is optimized (that is, the value of i_{d} counteracts the reluctance torque Tₑ based on equation [3]). The radii of the ellipses of the voltage limit 1810 may vary inversely with a speed of the rotor of the motor 308. In some embodiments, the ellipses of the voltage limit 1810 are distorted along the vertical q-axis because of a saturation effect, and the diameters of the ellipses of the voltage limit 1810 exhibit a counter-clockwise tilt along the horizontal d-axis because of stator resistance effects. At any given speed, the motor 308 can operate at any combination of i_{q} and is values that falls within the overlapping area of the current limit 1805 and the voltage limit 1810 associated with that speed. The value of negative I_{d} at which it completely opposes and negates the permanent magnet flux of the motor 308 is identified at 1815.

The graph 1800 also includes a first MTPA vector 1820 without the effects of magnetic saturation and a second MTPA vector 1825 with the effects of magnetic saturation. The first MTPA vector 1820 forms an angle with the negative d-axis that exceeds 45°, while the second MTPA vector 1825 forms an angle with the negative q-axis that does not exceed 45°. The graph 1800 also includes a maximum output power point 1830 that follows the periphery of the current limit 1805 towards the negative d-axis. This motion may be forced by the increasing speed that progressively shrinks the voltage limit 1810, preventing the machine from operating based on the MTPA algorithm, identified by a dashed line 1835.

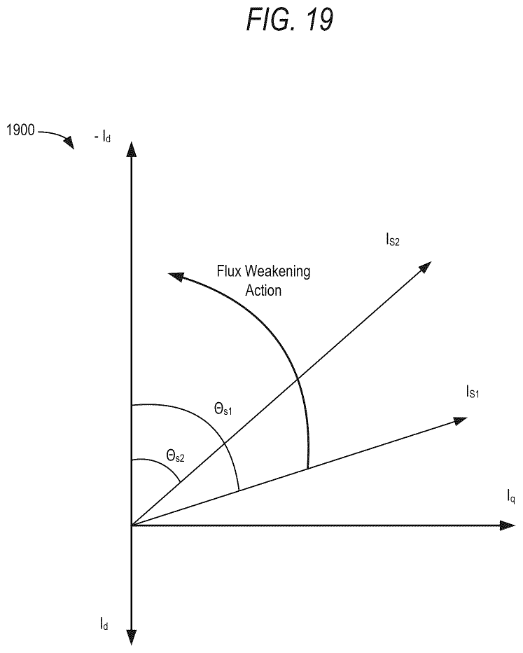

The maximum output power point 1830 for speeds above the corner point may be an optimistic outer limit for the current vector locus that can only be approached but never quite reached for an actual current regulated drive. This is true because the outer boundary of the voltage limit 1810 at any speed corresponds to six-step voltage operation, representing a condition in which current regulator loops are completely saturated. Since a current regulator loses control of phase currents under such conditions, the current vector command can be continually adjusted so that it always resides safely inside the voltage limit 1810. However, it is desirable to approach the voltage limit 1810 as closely as possible under heavy load conditions in order to deliver maximum power from the motor 308, taking full advantage of the power supplied by the inverter 348. Therefore, the angle between the commanded current vector and the negative d-axis is reduced as the shrinking voltage limit 1810 progressively intrudes on the current limit 1805 for speeds above the corner point. This can be controlled by an MTPV algorithm, explained below with respect to FIGS. 19-21.

FIG. 19 is a graph 1900 illustrating the results of a sensorless field weakening operation. Specifically, FIG. 19 illustrates how the angle, θs, between the commanded current vector, Iₛ, is reduced as the shrinking voltage limit 1810 (see FIG. 18) progressively intrudes on the current limit 1805 for speeds above the corner point. This action illustrated in FIG. 19 forms the basis for implementing an MTPV control algorithm.

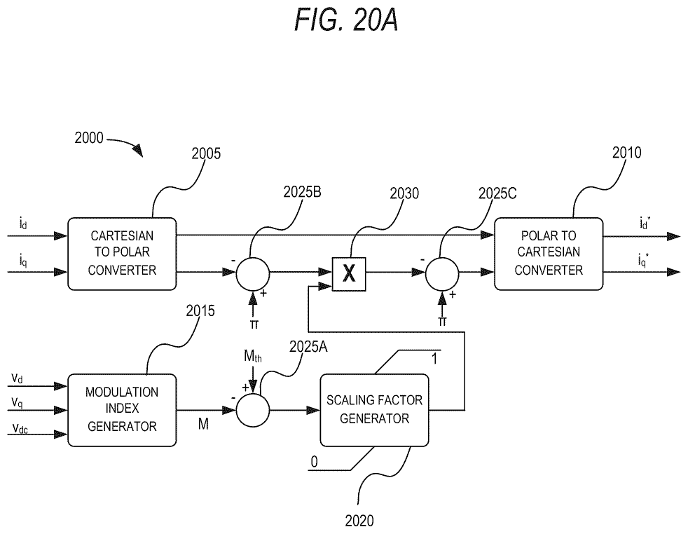

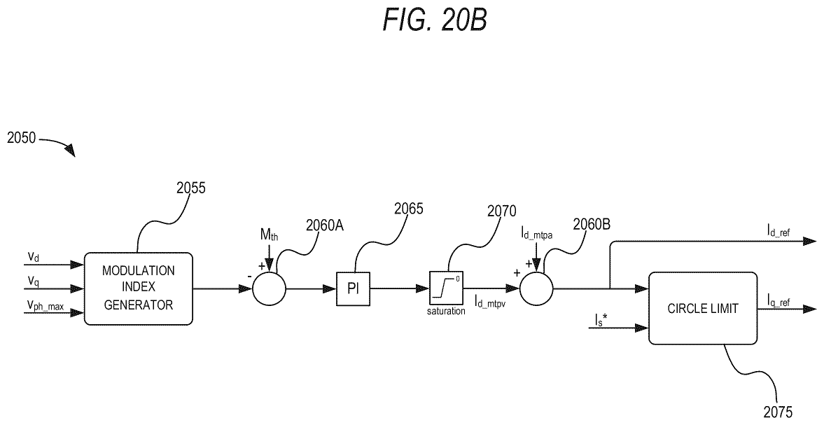

FIG. 20A is a block diagram of a control system 2000 for an MTPV algorithm, according to a first embodiment. The control system 2000 includes a cartesian-to-polar converter 2005 configured to receive a first signal corresponding to stator flux current i_{d} and a second signal corresponding to stator torque current i_{q}, and convert these signals from cartesian values to polar values. The cartesian-to-polar converter 2005 is configured to output a first signal corresponding to the polar i_{d} value and a second signal corresponding to the polar i_{q} value. The control system 2000 further includes a polar-to-cartesian converter 2010 configured to receive a first signal corresponding to the polar i_{d} value and a second signal corresponding to the polar i_{q} value. The polar i_{d} value may be received directly from the cartesian-to-polar converter 2005, while the polar i_{q} value may be received by an intervening control block.

The control system 2000 includes a modulation index generator 2015 configured to receive a first input signal v_{d} corresponding to a flux voltage, a second input signal v_{q} corresponding to a torque voltage, and a third input signal V_{dc} corresponding to a DC link voltage applied to the inverter 348. The modulation index generator 2015 generates a PWM modulation index M based on the three input signals according to equation (8).

$$M = \frac{\sqrt{{( {v}_{d} )}^{2} + {( {v}_{d} )}^{2}}}{\frac{2}{π} {v}_{dc}} \qquad ( 8 )$$

The modulation index generator 2015 outputs the PWM modulation index M. The control system 2000 further includes a first addition/subtraction block 2025A configured to receive and add an Mth value, wherein the Mth value is a preset modulation threshold value. The first addition/subtraction block 2025A also receives and subtracts the PWM modulation index M from the modulation index generator 2015. The first addition/subtraction block 2025A is further configured to output a signal corresponding to a result of the first addition/subtraction block 2025A. The control system 2000 includes a scaling factor generator 2020 configured to generate and output a signal corresponding to a scaling factor β between 0 and 1 based on the received signal from the first addition/subtraction block 2025A. By generating a scaling factor of between 0 and 1, only the angle of the current vector Iₛ, and not its amplitude, is directly controlled by the MTPV algorithm. Therefore, by using a scaling factor β of 1, the current vector generated by the MTPA control system 1600 is not affected. Referring back to FIG. 13, by using a scaling factor β of 1, the MTPV block 1315 is effectively ignored while the field weakening controller 1305 calculates values for i_{d}* and i_{q}*.

The control system 2000 also includes a second addition/subtraction block 2025B configured to receive and add a first signal π corresponding to Pi and receive and subtract a second signal corresponding to the polar torque current i_{q} from the cartesian-to-polar converter 2005. The second addition/subtraction block 2025B is configured to output a signal corresponding to a result of the second addition/subtraction block 2025B. The control system 2000 further includes a multiplication block 2030 configured to receive a first signal β from the scaling factor generator 2020 corresponding to the generated scaling factor between 0 and 1, and a second signal from the second addition/subtraction block 2025B corresponding to a result of the second addition/subtraction block 2025B. The multiplication block 2030 is configured to output a signal corresponding to a product of the first signal and the second signal. The control system 2000 includes a third addition/subtraction block 2025C configured to receive and add a first signal π corresponding to Pi (e.g., Pi radians) and receive and subtract a second signal from the multiplication block 2030 corresponding to a result of the multiplication block 2030. The third addition/subtraction block 2025C is configured to output a signal corresponding to a result of the third addition/subtraction block 2025C. The polar-to-cartesian converter is configured to receive this signal from the third addition/subtraction block 2025C.

FIG. 20B is a block diagram of a control system 2050 for an MTPV algorithm, according to a second embodiment. The control system 2050 includes a modulation index generator 2055 configured to receive a first input signal v_{d} corresponding to a flux voltage, a second input signal v_{q} corresponding to a torque voltage, and a third input signal V_{ph_max} corresponding to a DC link voltage applied to the inverter 348. The modulation index generator 2055 generates a PWM modulation index M based on the three input signals according to equation (9).

$$M = \frac{\sqrt{{( {v}_{d} )}^{2} + {( {v}_{d} )}^{2}}}{\frac{2}{π} {v}_{ph \_ max}} \qquad ( 9 )$$

The modulation index generator 2055 outputs the PWM modulation index M. The control system 2050 further includes a first addition/subtraction block 2060A configured to receive and add an Mth value, wherein the Mth value is a preset modulation threshold value. The first addition/subtraction block 2060A also receives and subtracts the PWM modulation index M from the modulation index generator 2055. The first addition/subtraction block 2060A is further configured to output a signal corresponding to a result of the first addition/subtraction block 2060A. The control system 2050 includes a PI block 2065 configured to receive the signal from the first addition/subtraction block 2060A. The PI block 2065 is further configured to output a signal corresponding to a result of the PI block 2065. The signal output by the PI block 2065 is received by a saturation block 2070. The saturation block 2070 is configured to output a signal corresponding to a result of the saturation block 2070, which is a d-axis component of an MTPV current vector I_{d_mtpv}.

The control system 2050 further includes a second addition/subtraction block 2060B configured to receive and add I_{d_mtpv}, as well as receive and add a signal corresponding to a d-axis component of an MTPA current vector I_{d_mtpa}. I_{d_mtpa} may be received from an MTPA control block, such as MTPA block 1610 of FIG. 16. The second addition/subtraction block 2060B is further configured to output a signal corresponding to a result of the second addition/subtraction block 2060B. The signal output by the second addition/subtraction block 2060B is a d-axis component of a reference current vector I_{d_ref}. I_{d_ref} is an output signal provided by the control system 2050. I_{d_ref} is also received by a circle limit block 2075 of the control system 2050. The circle limit block 2075 is further configured to receive a current signal Iₛ*. The circle limit block 2075 is configured to output a signal corresponding to a result of the circle limit block 2075. The signal is a q-axis component of a reference current vector I_{q_ref}. I_{q_ref} is an output signal provided by the control system 2050.

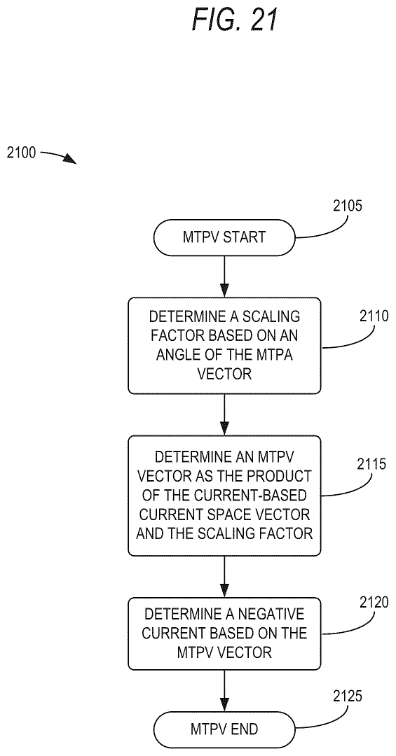

FIG. 21 is a flow chart of a method 2100 for implementing an MTPV algorithm. The method 2100 begins when a controller executing the method 1800 receives a command to begin the MTPV algorithm (BLOCK 2105). The method includes determining a scaling factor based on an angle of the MTPA vector output by the MTPA algorithm (for example, in BLOCK 1725 of FIG. 17) (BLOCK 2110). The scaling factor may be between 0 and 1. The method 2100 also includes determining an MTPV vector as the product of the MTPA vector and the scaling factor (BLOCK 2115). In some embodiments, the scaling factor is 1. In these embodiments, the MTPV vector is the same as the MTPA vector. The method 2100 also includes determining a negative current based on the MTPV vector (BLOCK 2120). The negative current may be the flux current component i_{d} of the MTPV vector, that is, i_{d}. Once the negative current has been identified, the MTPV algorithm has been completed and the method 2100 ends (BLOCK 2125).

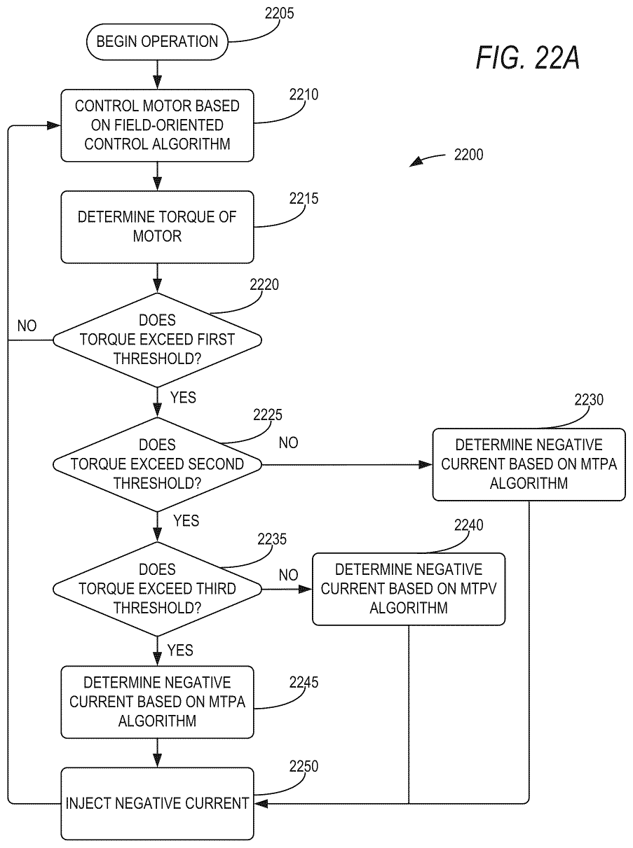

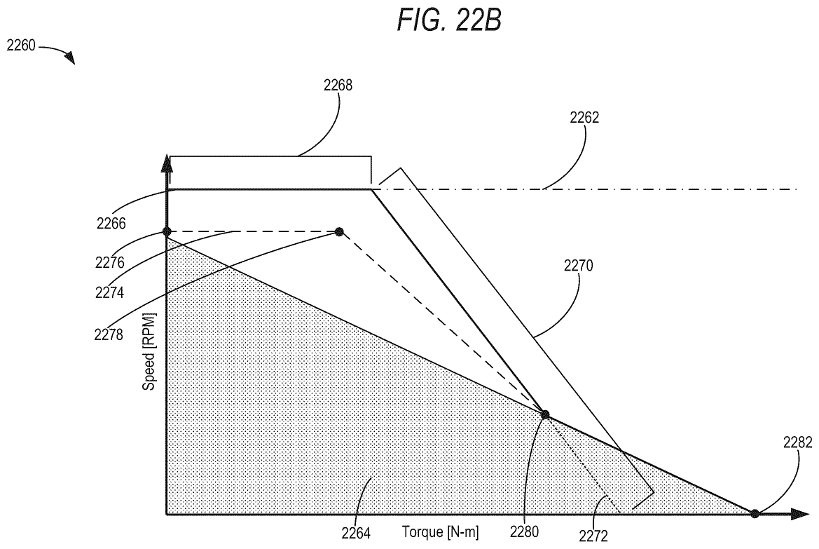

FIG. 22A is a flow chart of a method 2200 for implementing sensorless field weakening in the nailer 10 based on the above disclosures. The method 2200 begins when the nailer 10 begins operation (BLOCK 2205). In some embodiments, the nailer 10 may be capable of switching between field weakening and non-field weakening modes. The method 2200 includes controlling the motor 308 of the nailer 10 based on a sensorless field-oriented control (“FOC”) algorithm (BLOCK 2210). The FOC algorithm may be implemented on the FOC controller 1335. The method 2200 then includes determining a torque of the motor 308 (BLOCK 2215). The method 2200 may determine torque based on the torque observer 1350. The method 2200 then determines if the torque exceeds a first predetermined threshold (BLOCK 2220). In some embodiments, the first predetermined threshold is 0 Nm (i.e., sensorless field weakening is implemented whenever the sensorless motor is in an operating mode). If the torque does not exceed the first predetermined threshold, the method 2200 then returns to BLOCK 2210. In some embodiments, the method 2200 may include determining a parameter of the sensorless motor other than the torque in BLOCK 2215. For example, the method 2200 may instead determine a speed, a temperature, an operating time, or another parameter. In these embodiments, the first predetermined threshold (and other thresholds) may be based on the determined parameter. For example, in an embodiment in which motor speed is determined, the first predetermined threshold may be a speed threshold.

Returning to BLOCK 2220, if the method 2200 determines that the torque does exceed the first predetermined threshold, the method 2200 includes determining if the torque also exceeds a second predetermined threshold (BLOCK 2225). If the torque does not exceed the second predetermined threshold, the method 2200 includes determining a negative stator flux current based on a max-torque-per-amps (“MTPA”) algorithm, such as the algorithm described by FIG. 17 (BLOCK 2230). Returning to BLOCK 2225, if the method 2200 determines that the torque does exceed the second predetermined threshold, the method 2200 includes determining if the torque also exceeds a third torque threshold (BLOCK 2235). If the torque does not exceed the third predetermined threshold, the method 2200 includes determining a negative stator flux current based on a max-torque-per-volts (“MTPV”) algorithm, such as the algorithm described by FIG. 21 (BLOCK 2240). Returning to BLOCK 2235, if the method 2200 determines that the torque does exceed the third predetermined threshold, the method 2200 includes determining a negative stator flux current based on the MTPA algorithm, such as the algorithm described by FIG. 17 (BLOCK 2245). Following the determination of a negative stator flux current by any of BLOCKS 2230, 2240, or 2245, the method 2200 also includes injecting the negative stator flux current into the motor 308 to weaken a magnetic field generated by the rotor, therefore increasing the speed of the rotor (BLOCK 2250). It is important to note that the method 2200 requires significant processing power to complete the associated MPTA and MPTV algorithms. Conventional nailers (e.g., handheld nailers) lack the processing power required to implement the method 2200. However, the nailer 10 is capable of implementing the method 2200.

FIG. 22B is a graph 2260 illustrating the output of the nailer 10 implementing the method 2200 of FIG. 22A. The x-axis of the graph 2260 represents torque of the nailer 10 in Newton-meters. The y-axis of the graph 2260 represents speed of the nailer in revolutions-per-minute. The graph 2260 includes an upper speed threshold 2262 representing a maximum operating speed of the nailer 10. In some embodiments, the upper speed threshold 2262 is 30,000 RPM. The graph 2260 also includes a region illustrating a speed-torque curve 2264 of the nailer 10 without implementing the method 2200 of FIG. 22A. The graph 2260 also includes a solid line representing a maximum operating envelope 2266 of the nailer 10. The maximum operating envelope 2266 indicates a set of maximum operating parameters for the nailer 10. The maximum operating envelope 2266 includes two regions. The first region 2268 indicates a region in which motor speed is optimized. The second region 2270 indicates a region in which motor current and/or efficiency is optimized. The graph 2260 also includes a dotted line representing a maximum field weakening envelope 2272. The area within the maximum field weakening envelope 2272 is a region in which field weakening has the greatest effect.

The graph 2260 also includes a dashed line representing a configured operating envelope 2274. The configured operating envelope 2274 indicates a set of operating parameters of the nailer while implementing the method 2200 of FIG. 22A. The configured operating envelope 2274 illustrates that, over a low-torque range, the speed of the motor is optimized. The low-torque range of the configured operating envelope 2274 is between a first point 2276 representing a peak speed of the motor at no load and a second point 2278 representing a knee point. The knee point is a point in which the speed of the motor begins to reduce. In some embodiments, the speed of the motor reduces naturally based on the torque of the motor. The configured operating envelope 2274 also illustrates that, over a medium-torque range, the speed of the motor gradually decreases as the torque increases. The medium-torque range is between the second point 2278 and a third point 2280 representing a crossover point. The crossover point is a point at which the maximum operating envelope 2266 crosses the speed-torque curve 2264 of the nailer not implementing the method 2200. The configured operating envelope 2274 also illustrates that, over a high-torque range, the speed of the motor gradually decreases as the torque increases, the speed decreasing at a rate slower than over the medium-torque range. The high-torque range is between the third point 2280 and a fourth point 2282 representing a peak torque of the nailer.

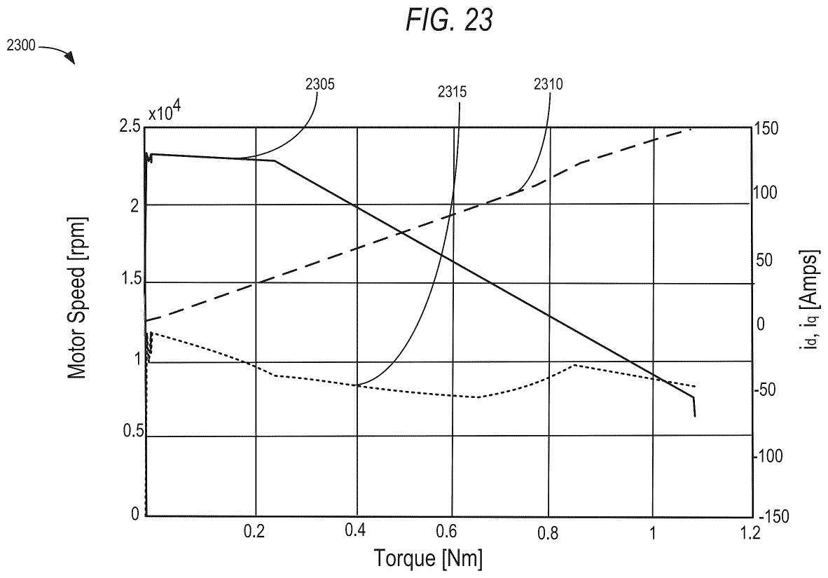

FIG. 23 is a graph 2300 illustrating a relationship between motor speed, motor torque, stator flux current, and stator torque current of the motor 308. As can be seen by the graph 2300, as the torque of the motor 308 increases, the speed of the motor 308 decreases, represented by a speed-torque curve represented by the solid line 2305. Additionally, the graph 2300 illustrates that as the torque of the motor 308 increases, the stator torque current increases almost linearly, represented by the dashed line 2310. Additionally, the graph 2300 illustrates that as the torque of the sensorless motor increases, the stator flux current is decreased, as represented by the dotted line 2315. At about 0.25 Nm of torque, the stator flux current begins decreasing at a slightly lessened rate. Between about 0.7 Nm and 0.85 Nm of torque, the stator flux current spikes, before decreasing again. The fluctuation of the stator flux current illustrates the differences in the MTPA algorithm and the MTPV algorithm. For example, the MTPA algorithm is employed before about 0.25 Nm and after about 0.85 Nm, while the MTPV algorithm is employed between these values. In some embodiments, these threshold values are different.

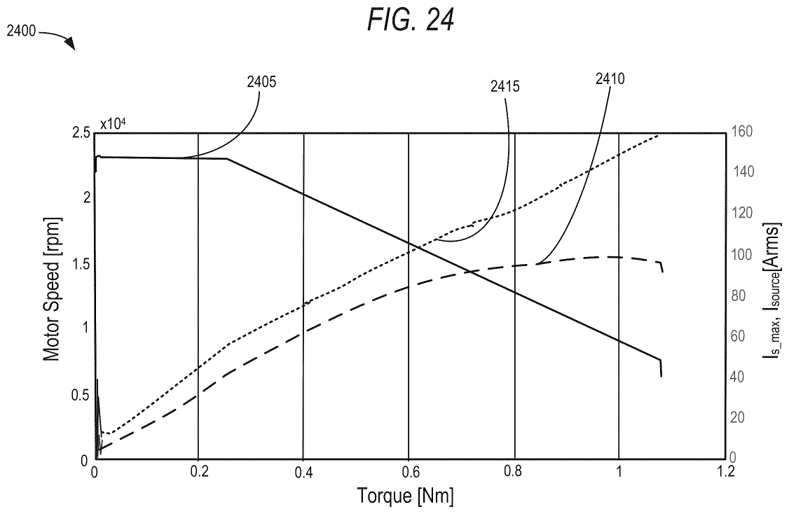

FIG. 24 is a graph 2400 illustrating a relationship between motor speed, motor torque, stator current, and source current of the sensorless motor 308. The solid line 2405 may represent the same speed-torque curve as FIG. 23. As torque increases, the rate of growth of a source current begins to reduce, specifically after about 0.6 Nm, as represented by the dashed line 2410. By contrast, as torque increases, the maximum stator current increases at a generally linear rate, as represented by the dashed line 2415. This illustrates that the motor, while operating under high torque, cannot maximize the available current, thereby reducing motor speed. Therefore, it is favorable to employ a sensorless field weakening algorithm as described.

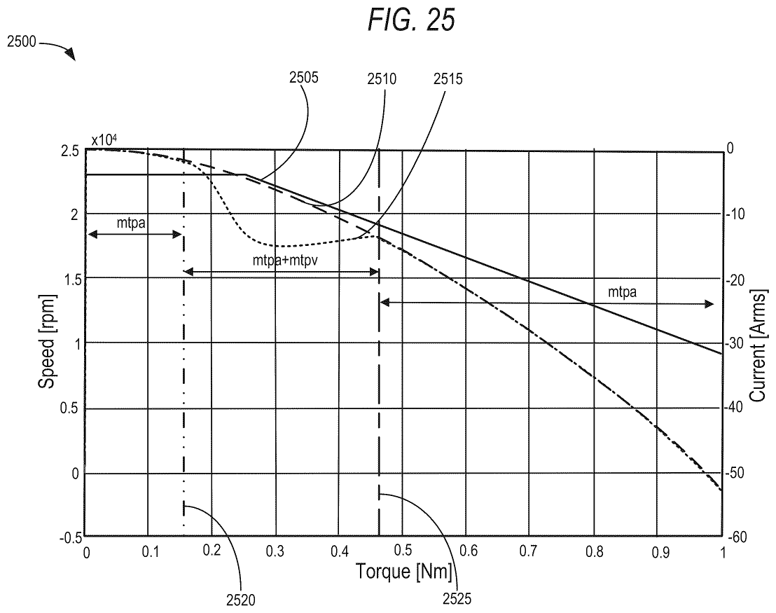

FIG. 25 is a graph 2500 illustrating a relationship between motor speed, motor torque, a negative stator flux current determined by an MTPA algorithm, and a negative stator flux current determined by an MTPV algorithm. The solid line 2505 may represent the same speed-torque curve as FIG. 23. As torque increases while using solely an MTPA algorithm, the negative stator flux current decreases (i.e., becomes more negative) as a quadratic decay function, as represented by the dashed line 2510. By contrast, as torque increases while using a combination of an MTPA algorithm and an MTPV function, the stator flux current decreases as the same quadratic decay function before a first predetermined threshold represented by the dashed-and-dotted line 2520 and after a second predetermined threshold represented by the long-dashed line 2525. The stator flux current while implementing the combination of an MTPA algorithm and an MTPV algorithm is represented by the dotted line 2515. In some embodiments, the first and second predetermined thresholds are second and third predetermined thresholds, with a first predetermined threshold at a minimum torque value (e.g., 0 Nm). Between the first and second predetermined thresholds, the stator flux current decreases as a much steeper quadratic decay function, before increasing (i.e., becoming less negative) as a linear function. As illustrated by FIG. 25, 0 Nm is a first torque threshold, 0.175 Nm is a second torque threshold, and 45 Nm is a third torque threshold. These thresholds can be used by the method 2200 of FIG. 22A in determining which field weakening algorithm (or combination thereof) to use. In some embodiments, these thresholds may be at different values.

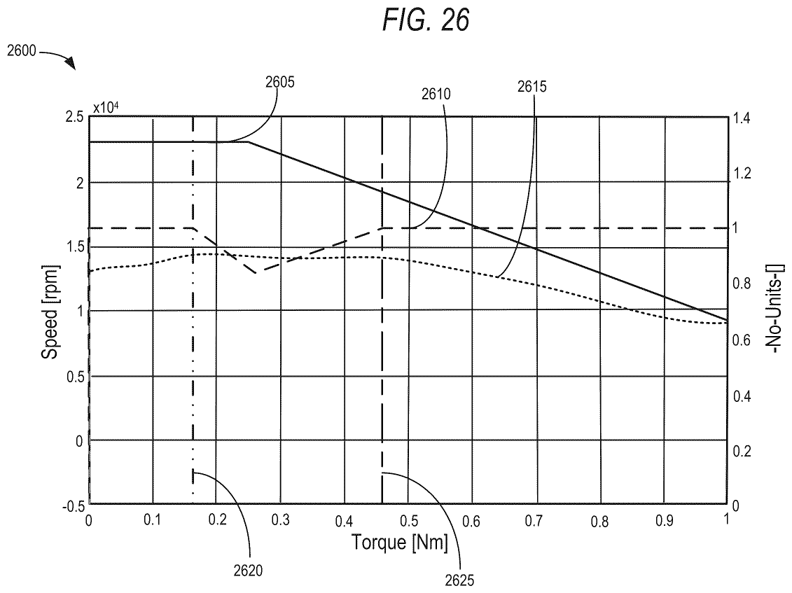

FIG. 26 is a graph 2600 illustrating a relationship between motor speed, motor torque, a correction factor used in an MTPV algorithm, and a modulation index used in an MTPV algorithm. The solid line 2605 represents the same speed-torque curve as FIG. 23. As torque increases, the MTPV scaling factor stays constant at 1 before a first predetermined threshold represented by the dashed-and-dotted line 2620 and after a second predetermined threshold represented by the long-dashed line 2625 and decreases linearly to roughly 0.8 before increasing linearly back to 1 between the first and second predetermined thresholds. The MTPV scaling factor is represented by the dashed line 2610. Similarly, the modulation index increases to about 0.9 before the first predetermined threshold, remains constant at about 0.9 between the first and second predetermined thresholds, and decreases after 0.45 Nm after the second predetermined threshold, as represented by the dotted line 2615. This illustrates the relationship between scaling factor and modulation index in performing the MTPV algorithm. As with FIG. 25, 0 Nm is a first torque threshold, 0.175 Nm is a second torque threshold, and 0.45 Nm is a third torque threshold. These thresholds can be used by the method 2200 of FIG. 22A in determining which field weakening algorithm (or combination thereof) to use. In some embodiments, these thresholds may be at different values.

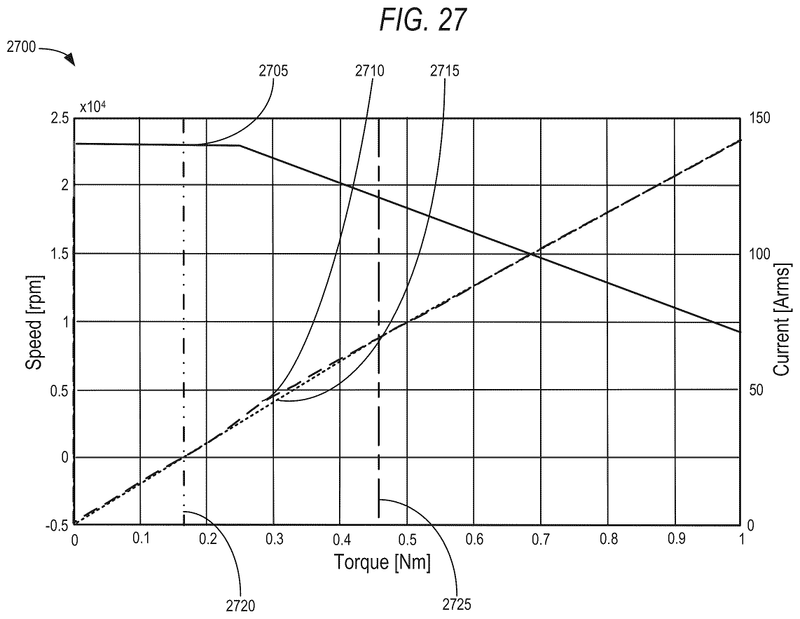

FIG. 27 is a graph 2700 illustrating a relationship between motor speed, motor torque, a stator torque current determined by an MTPA algorithm, and a stator torque current determined by an MTPV algorithm. The solid line 2705 represents the same speed-torque curve as FIG. 23. As torque increases the stator torque current increases linearly during both the MTPA algorithm and the MTPV algorithm, as represented by the dashed line 2710 and the dotted line 2715, respectively. While implementing MTPA only, the stator torque current fluctuates slightly between a first predetermined threshold represented by the dashed-and-dotted line 2720 and a second predetermined threshold represented by the long-dashed line 2725. This illustrates the range at which implementing the MTPV algorithm is necessary in order to maintain the stator torque current at a linearly increasing rate. As with FIG. 25, 0 Nm is a first torque threshold, 0.175 Nm is a second torque threshold, and 0.45 Nm is a third torque threshold. These thresholds can be used by the method 2200 of FIG. 22A in determining which field weakening algorithm (or combination thereof) to use. In some embodiments, these thresholds may be at different values.

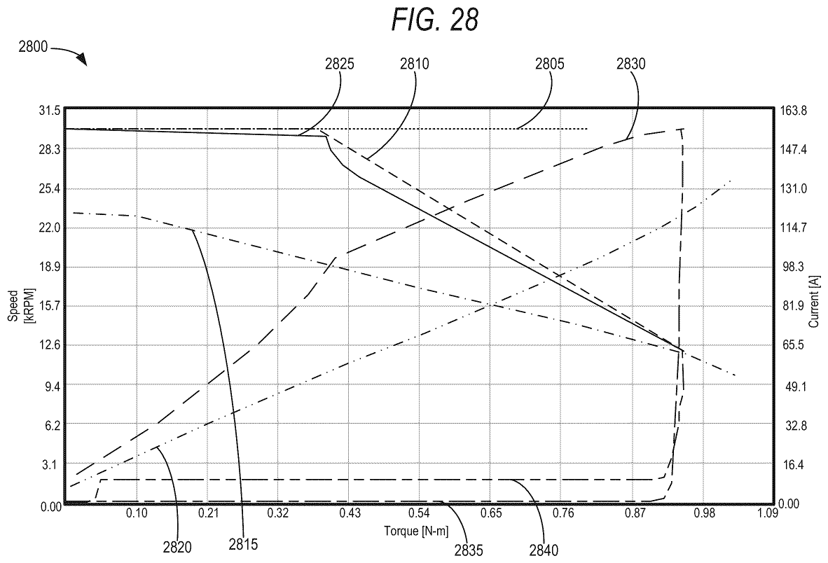

FIG. 28 is a graph 2800 illustrating relationships between motor torque and motor speed, and motor torque and motor current. The x-axis of the graph 2800 represents a torque of the motor, measured in Newton-meters. The y-axis of the graph 2800 represents speed of the motor (left) measured in kilo-revolutions-per-minute, and current drawn by the motor (right) measured in amps. The graph 2800 includes a first speed reference 2805. The first speed reference 2805 may be implemented by a baseline controller (that is, a controller that does not implement field weakening) for use in controlling the speed of a motor controlled by the baseline controller. The graph 2800 also includes a speed reference map 2810. The speed reference map 2810 is a set of reference speeds corresponding to various measured torques. The speed reference map 2510 may be used to control a speed of a motor implementing sensorless field weakening based on a measured torque (for example, via the LUT 1320 of FIG. 13).

The graph 2800 also includes a first speed-torque curve 2815 for the baseline motor, and a first current-torque curve 2820 for the baseline motor. The first speed-torque curve 2815 and the first current-torque curve 2820 show that the baseline motor operates at a maximum speed until a knee point, at which speed begins to reduce naturally as torque and current increase. The graph 2800 also includes a second speed-torque curve 2825 for the field-weakening motor and a second current-torque curve 2830 for the field-weakening motor. The second speed-torque curve 2825 and the second current-torque curve 2830 show that the field weakening motor operates at a speed corresponding to the speed reference map 2810 based on a measured torque. The field weakening motor is able to maintain a relatively higher speed compared to the baseline motor by implementing field weakening. The field weakening motor additionally draws more current than the baseline motor. The graph 2800 also includes a first line 2835 and a second line 2840.

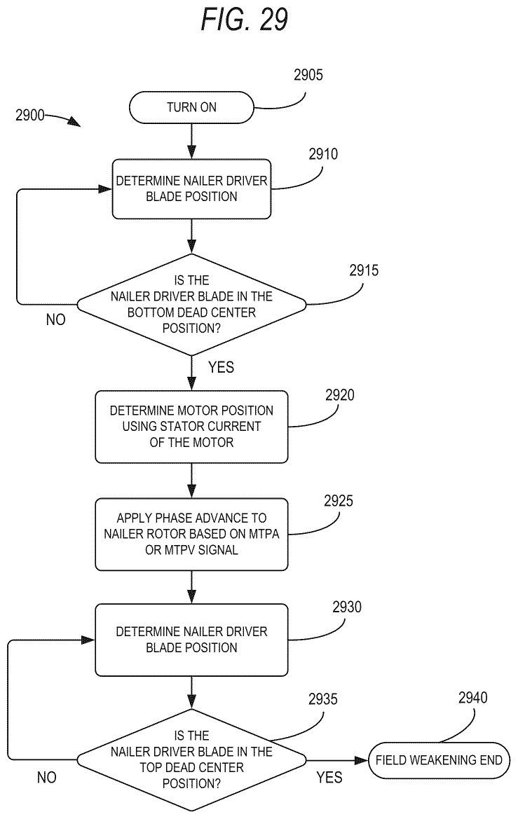

FIG. 29 is a flow chart of a method 2900 for implementing sensorless field weakening control of the nailer 10. The method 2900 begins when the nailer 10 is turned on and the controller 304 the configured to execute the method 2900 and begins control of the motor 308 based on receiving power (BLOCK 2905). The controller 304 determines the nailer driver blade 26 position (BLOCK 2910) based on, for example, a sensed position of the driver blade 26 (e.g., based on motor rotational position, a sensor that directly detects the position of the driver blade 26, etc.). If the driver blade 26 position is determined to be in the BDC position (BLOCK 2915), the controller 304 determines the position of the motor 308 (i.e., rotor position) based on stator current Is (BLOCK 2920). If the driver blade 26 is not determined to be in the BDC position, the method 2900 returns to BLOCK 2910 to determine driver blade 26 position. Once motor 308 position is determined (BLOCK 2920), the controller 304 generates a command to apply field weakening to the rotor of motor 308 (BLOCK 2925) based on the MTPA 1310 or MTPV 1315 algorithm. The controller 304 determines the driver blade 26 position again using FOC (BLOCK 2930). If the driver blade 26 is determined to be in the TDC position (BLOCK 2935), the controller 304 generates a command to end field weakening of the motor 308 (BLOCK 2940) by removing the command to apply field weakening. If the driver blade 26 is not determined to be in the TDC position, the method 2900 returns to BLOCK 2930 to continue field weakening of the motor 308.

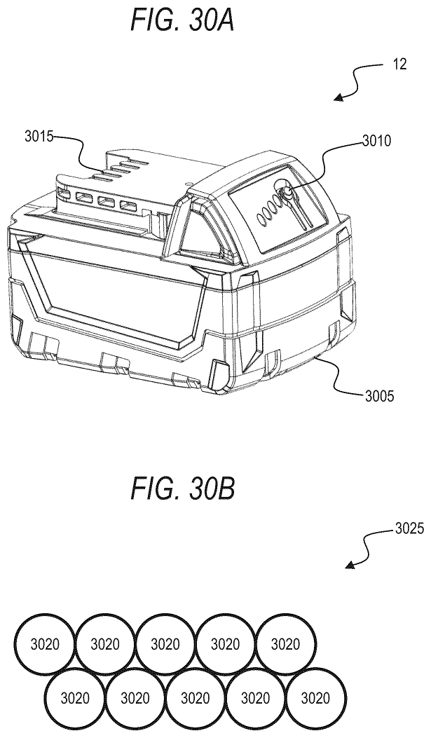

Additional or alternative techniques for controlling field weakening in a power tool can also be implemented. For example, FIG. 30A illustrates the rechargeable battery pack 12 according to some embodiments. The rechargeable battery pack 12 includes a housing 3005, a user interface portion 3010 for providing a state-of-charge indication for the rechargeable battery pack 12, and a device interface portion 3015 for connecting the rechargeable battery pack 12 to a device (e.g., a power tool, the nailer 10, etc.). The rechargeable battery pack 12 includes a plurality of battery cells 3020 within the housing 3005.

FIG. 30B illustrates a group 3025 of the battery cells 3020 that include, for example, ten individual battery cells 3020. The battery cells 3020 can be located within the housing 3005 of the rechargeable battery pack 12. In some embodiments, the rechargeable battery pack 12 includes more or fewer than 10 battery cells within the housing 3005.

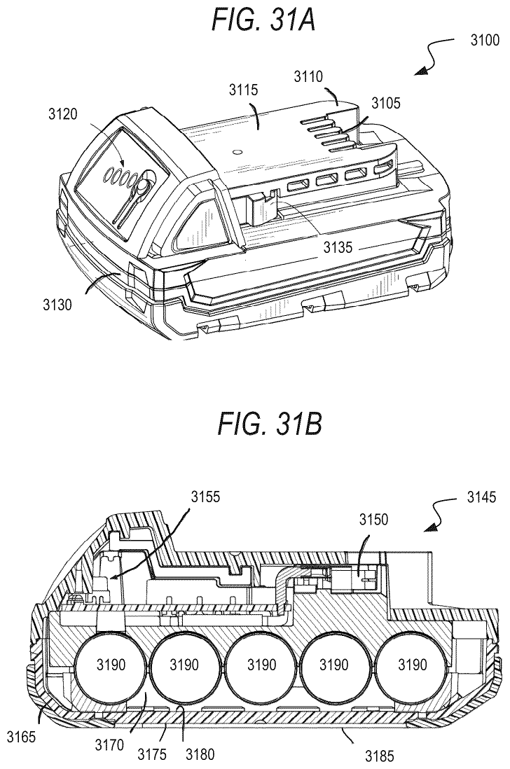

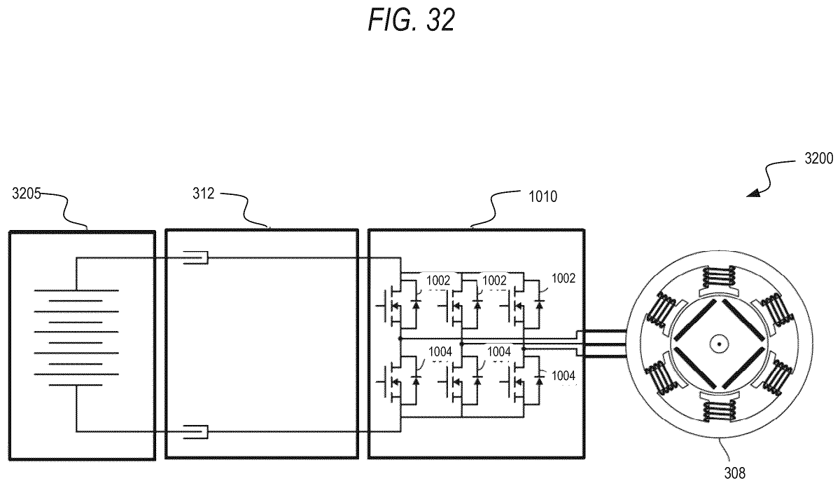

FIG. 31A illustrates a battery pack 3100, such as the rechargeable battery pack 12, for powering a power tool. The battery pack 3100 includes a battery housing 3130 and, with reference to FIG. 31B, a plurality of battery cells 3190.

FIG. 31B illustrates an interior view 3145 containing the battery housing 3130, which includes a wall 3165 having an inside surface 3180 and an outside surface 3175. The inside surface 3180 defines an internal cavity 3170. The outside surface 3175 includes a top surface portion 3115 (FIG. 31A) and a bottom portion 3185. Referring to FIG. 31B, the battery cells 3190 disposed within the cavity 3170 are connected in series to battery contacts 3105. Referring back to FIG. 31A, a plurality of contacts 3105 (FIG. 31B) are disposed on the top surface portion 3115, within a battery contacts housing extension 3110. The housing extension 3110 is configured to matingly engage with one or more power tools or powered accessories. A battery charge level indicator 3120 is also disposed on the housing (FIG. 31A), while additional battery charging, monitoring, and indication components 3155 are disposed within the cavity 3170 (FIG. 31B). As shown in FIG. 31A, two tabs 3135 are coupled to the housing 3130 for releasably securing the housing 3130 to a power tool device. Corresponding features to those described above with respect to the battery pack 3100 can also be included in the rechargeable battery pack 12.

FIG. 32 illustrates a circuit diagram 3200 of the switching module 1010. The switching module 1010 includes a number of high side power switching elements 1002 and a number of low side power switching elements 1004. The controller 304 provides the control signals to control the high side FETs 1002 and the low side FETs 1004 to drive the motor 308 based on the motor feedback information and user controls, as described above. For example, in response to detecting activation of the trigger switch 316 the controller 304 provides the control signals to selectively enable and disable the FETs 1002 and 1004 (e.g., sequentially, in pairs) resulting in power from the power source 3205 (e.g., the rechargeable battery pack 12) to be selectively applied to stator coils of the motor 308 to cause rotation of a rotor. More particularly, to drive the motor 308, the controller 304 enables a first high side FET 1002 and first low side FET 1004 pair (e.g., by providing a voltage at a gate terminal of the FETs) for a first period of time. In response to determining that the rotor of the motor 308 has rotated based on a pulse from the one or more sensors 324, the controller 304 disables the first FET pair, and enables a second high side FET 1002 and a second low side FET 1004. In response to determining that the rotor of the motor 308 has rotated based on pulse(s) from the one or more sensors 324, the controller 304 disables the second FET pair, and enables a third high side FET 1002 and a third low side FET 1004. This sequence of cyclically enabling pairs of high side FET 1002 and low side FET 1004 repeats to drive the motor 308. Further, in some embodiments, the control signals include pulse width modulated (PWM) signals having a duty cycle that is set based on the trigger switch 316, to thereby control the speed or torque of the motor 308.

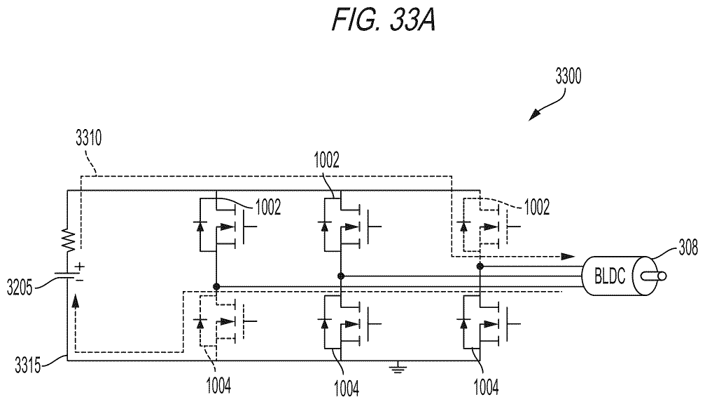

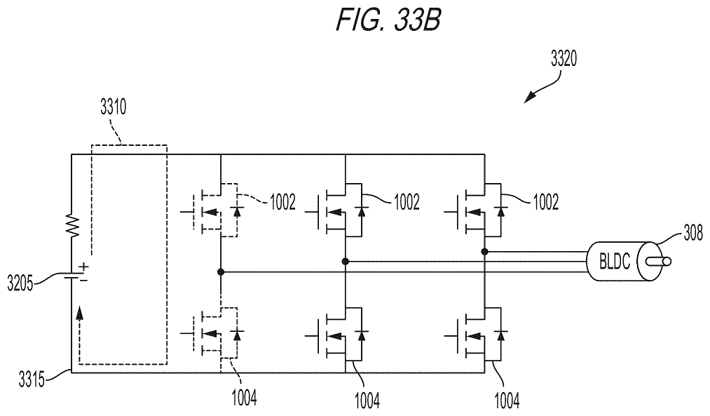

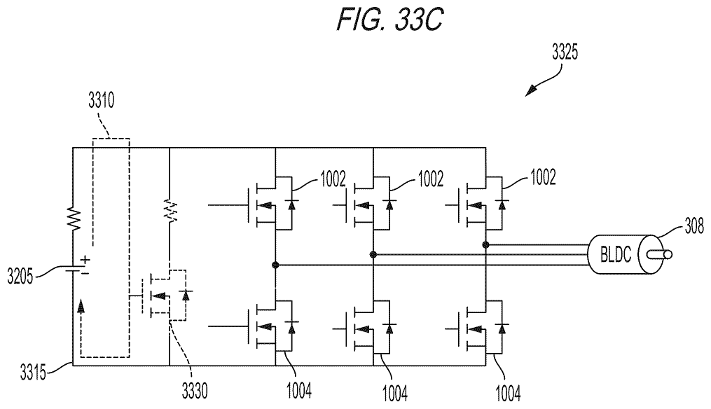

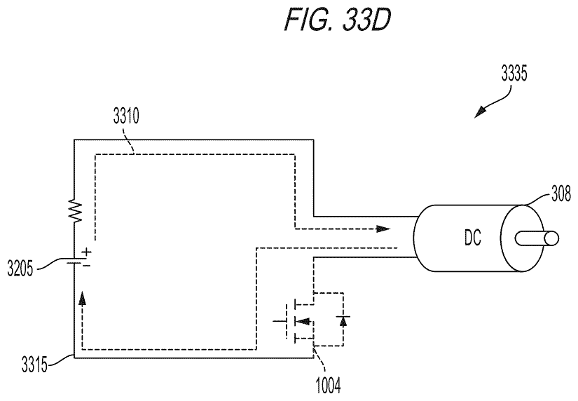

FIG. 33A illustrates a current flow diagram 3300 of the switching module 1010 for using current to determine battery pack impedance. The switching module 1010 includes the plurality of high side power switching elements 1002 and the plurality of low side power switching elements 1004, as described above. For example, in response to detecting activation of the trigger switch 316, the controller 304 provides the control signals to selectively enable and disable the FETs 1002 and 1004 (e.g., sequentially, in pairs) resulting in power being provided from the power source (e.g., rechargeable battery pack 12). Current 3310 travels from the power source 3205 through one of the high side power switching elements 1002 to stator coils of the motor 308. The current 3310 then travels from the motor 308 to one of the low side power switching elements 1004 before completing a path of connection 3315 of the power source 3205.

FIG. 33B illustrates another embodiment of a current flow diagram 3320 of the switching module 1010 for using current to determine battery pack impedance. The switching module 1010 includes the plurality of high side power switching elements 1002 and the plurality of low side power switching elements 1004, as described above. For example, in response to detecting activation of the trigger switch 316, the controller 304 provides the control signals to selectively enable and disable the FETs 1002 and 1004 (e.g., sequentially, in pairs) resulting in power being provided from the power source 3205 (e.g., the rechargeable battery pack 12). Current 3310 travels from the power source 3205 through one high side power switching elements 1002, to one low side power switching elements 1004. The current 3310 closes the circuit by then returning to the power source 3205. This reduced current 3310 path only travels through two switching FETs and completes a shorter portion of the path of connection 3315 of the power source 3205. In some embodiments, one or more high side power switching elements 1002 and/or one or more low side power switching elements 1004 are enabled at the same time. Such control may decrease the overall resistance of the system and enable higher current flow and distributing the load of the system through the FETs 1002 and 1004 to reduce FET 1002 and 1004 burnup.

FIG. 33C illustrates another embodiment of a current flow diagram 3325 of the switching module 1010 for using current to determine battery pack impedance. In this embodiment, an additional switching module 3330 is connected to the path of connection 3315. In addition to the additional switching module 3330, an additional resistor is connected to the path of connection 3315. For example, in response to detecting activation of the trigger switch 316, the controller 304 provides the control signals to selectively enable and disable the switching module 3330 resulting in power being provided from the power source 3205 (e.g., the rechargeable battery pack 12). Current 3310 travels from the power source 3205 through the additional resistor, then through the additional switching module 3330. The current 3310 only travels through the additional resistor and the additional switching module 3330 then returns to the power source 3205 to close the circuit. In other embodiments, an inductor can be used for similar purposes as the additional resistor. Additionally, other circuitry configurations may be configured in such a way that other components can be used (e.g., a capacitor).

FIG. 33D illustrates yet another embodiment of a current flow diagram 3335 of the switching module 1010 for using current to determine battery pack impedance. In this embodiment, only one power switching module 1004 is used. For example, in response to detecting activation of the trigger switch 316, the controller 304 provides the control signals to selectively enable and disable the power switching element 1004 resulting in power being provided from the power source 3205 (e.g., the rechargeable battery pack 12). Current 3310 travels from the power source 3205 to the motor 308 (e.g., a brushed motor), then to the power switching element 1004 before closing the path of connection 3315.

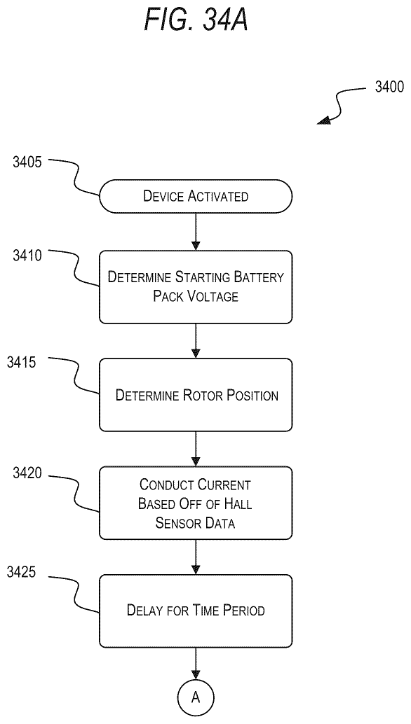

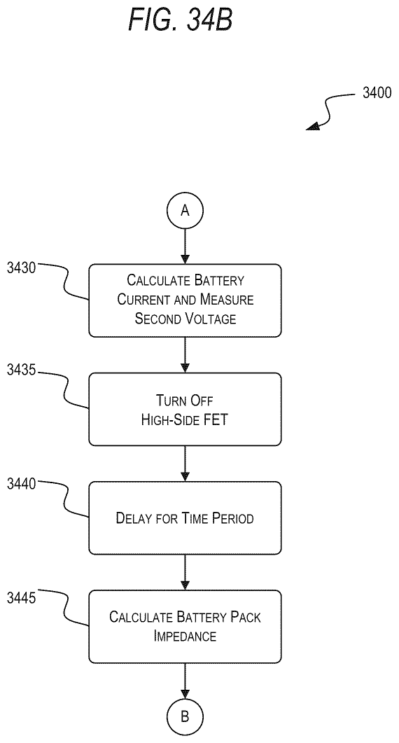

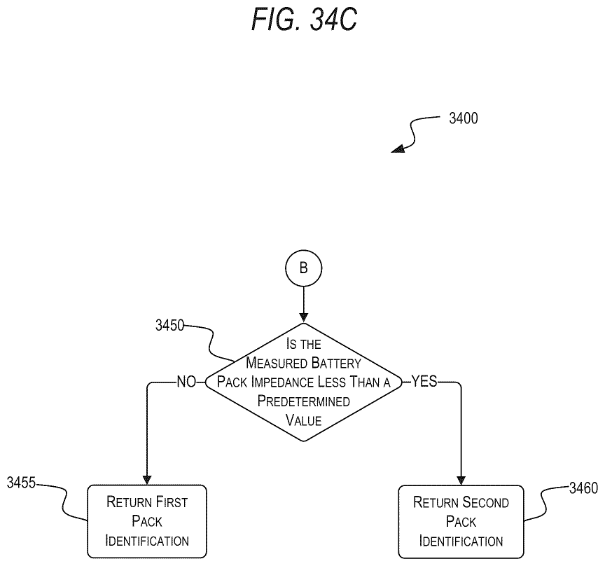

FIG. 34A illustrates a method 3400 executed by the controller 304 of the nailer 10 or another power tool. The nailer 10 or another power tool is activated (STEP 3405) to initialize the method 3400 by the controller 304. For example, the nailer 10 or another power tool may be activated by detecting activation of the trigger switch 316, which causes the battery pack 50 to deliver power to the nailer 10 or another power tool. The controller 304 receives or measures the battery pack voltage from the battery pack 50, and the controller 304 determines or calculates a starting battery pack voltage (STEP 3410). The nailer 10 or another power tool then receives one or more signals from the one or more sensors 324 (e.g., Hall Effect sensors 1020) related to a rotational position of the motor 308 (i.e., the rotor). Data corresponding to the one or more signals are stored within the memory 356 for determining rotor position (STEP 3415). In some embodiments, the power tool does not include Hall Effect sensors. Instead, the power tool uses back-emf or another parameter to sensorless determine the position of the motor. In other embodiments, an inrush technique can be used by enabling the high side switching elements 1002 and the low side switching elements 1004 to derive the position of the motor (e.g., through back-emf, Hall transition, etc.). In other embodiments, the motor 308 position may be ascertained by conducting multiple quick inrush pulses and comparing relative impedances. In other embodiments, the position of the motor is not used in the case where the inductance is similar regardless of motor rotation.

In some embodiments, STEPS 3415 and 3420 may be optional. If the location of the rotor is known, the current may flow through a path with ideal inductance. Higher inductance corresponds to a slower rise in current. This allows more time for the rise in current, which helps to take the measurement. If there is a fixed time period delay (described in further detail below), it also avoids draining too much current that might damage electrical components.

Using the data received from the aforementioned one or more sensors 324, the nailer 10 or other power tool initiates power to one or more high side power switches modules 1002, and one or more low side switching modules 1004, which consequently conducts current through the motor 308 (STEP 3420). A delay is then instituted to allow for a flow of current through the system (STEP 3425). The delay allows for the current to rise to a level that can be reliably read with sufficient resolution. Without the delay, there may not be a significant enough change in voltage or current. The length of the delay prevents burning up an electrical component (e.g., FET 1002 and 1004), as well as not allowing the motor to over significantly rotate. In some embodiments, the method is delayed approximately 40 μs. In other embodiments, longer or shorter delays can be implemented to avoid transient voltage or current spikes. In some embodiments, one of a hard busy wait is used. In some embodiments, a measurement includes multiple samples (e.g., of current and voltage).

FIG. 34B illustrates a continuation of the method 3400 executed by the controller 304. After implementing a delay at STEP 3425, the controller 304 is configured to sample a current sense input to an analog-to-digital converter (“ADC”) and receive or measure a second voltage (e.g., sampling a voltage sense input to an ADC). In some embodiments, multiple samples are taken within a measurement. The controller 304 uses the sampled current sense input to then calculate the current of the rechargeable battery pack 12, I_{bat}, and the second voltage measurement, V_{end} (STEP 3430). The controller 304 is then configured to turn off the low side power switches 1004 to allow the high side power switches 1002 to freewheel current (STEP 3435). Another delay is used to allow the high side power switches 1002 to freewheel current for an amount of time (STEP 3440). In some embodiments, the method is delayed approximately 100 μs. In other embodiments, longer or shorter delays can be implemented. After the second delay of the method 3400, the high side power switching 1002 is turned off.

Using the starting battery voltage from STEP 3410, the second battery voltage from STEP 3430, and the calculated current of the rechargeable battery pack 12 from STEP 3430, the controller 304 is configured to determine the impedance of the rechargeable battery pack 12. The impedance of the rechargeable battery pack 12 can be calculated by the controller 304 using, for example, equation (10).

$${Z}_{pack} = \frac{{V}_{start} - {V}_{end}}{{I}_{bat}} \qquad EQN . ( 10 )$$

Although EQN. (10) provides one example of how battery pack impedance can be determined, other techniques for determining battery pack impedance can also be used.

In another embodiment of estimating impedance of the battery pack, the rate of voltage drop and rate of current increase can be used in relation of the inductance of the system. The voltage drop is measured at least twice, and assumes a fixed inductance. In another embodiment of estimating impedance of the battery pack, the measurement of current alone may also be used to estimate general impedance of the battery pack. In another embodiment of estimating impedance of the battery pack, the integration of measured current over time may be used to find an estimation of the impedance of the battery pack. Similarly, the integration of voltage over time may be used to find an estimation of the impedance of the battery pack. Similarly, the derivative of the rising current and/or the derivative of the falling voltage may also be used to find an estimation of the impedance of the battery pack.

In another embodiment of estimating impedance of the battery pack, during an inrush current technique, voltage and current samples are measured to perform a slope calculation to find impedance. The slope calculation can feed into another algorithm (e.g., a neutral net, filter functions, etc.) to derive multiple aspects of the impedance (e.g., resistance, capacitance, inductive loading, etc.). Additionally, the inrush technique could be used with multiple inrush spikes and the results can be combined for a more precise output.

FIG. 34C is a continuation of method 3400. If, at STEP 3450, the calculated impedance is greater than or equal to a certain predetermined value (e.g., a value of 50 to 80 milli-Ohms), the controller 304 is configured to determine that the rechargeable battery pack 12 is a first type of battery pack (STEP 3455). If, at STEP 1150, the calculated impedance is less than the certain predetermined value, the controller 304 is configured to determine that the rechargeable battery pack 12 is a second type of battery pack (STEP 3460). In some embodiments, multiple impedance thresholds are included for determining the type of battery pack. In some embodiments, the impedance is a continuous parameter that is used to identify the type of battery pack (e.g., using a lookup table). In another embodiment, the voltage and/or current of the system may be measured by the battery pack. In other embodiments, the voltage and/or current measurements may be communicated to the tool (e.g., via digital or analog interface). In other embodiments, the battery pack may self-calculate its own impedance. The battery pack may communicate the self-calculated impedance of the battery pack to the power tool. In another embodiment, the power tool may calculate the impedance of the battery pack, then communicate the result of the calculation to the battery pack.

In some embodiments, the determination of the type of the battery pack may be probabilistic. In some embodiments, the type of the battery pack may be found by a thermal measurement. The thermal measurement of the battery pack may be found using a temperature sensor (e.g., a thermistor, thermocouple, etc.). Because impedance changes with temperature, the thermal measurement can be used to identify the most probable battery pack type.

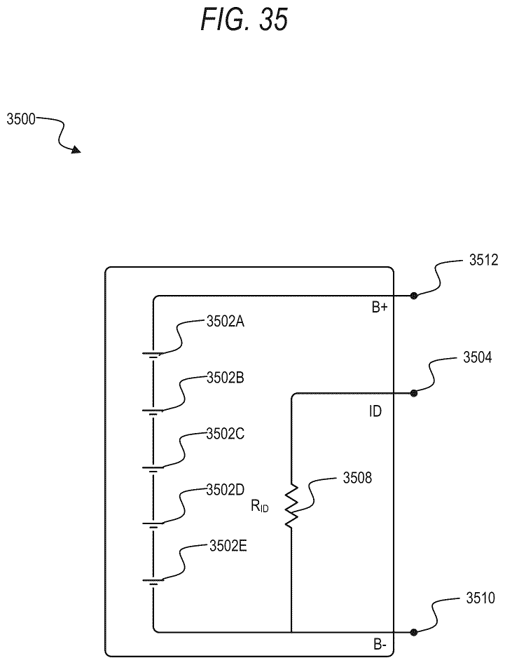

FIG. 35 illustrates a circuit for determining an identity of a battery pack 3500, according to some embodiments. The battery pack 3500 is coupled to a power tool, similar to those described above. The battery pack 3500 may be similar to the rechargeable battery pack 12 described above. The battery pack 3500 may include one or more power cells 3502A-E. The battery pack 3500 may also include an additional identification terminal 3504 that couples to an identification terminal (e.g., in the battery pack interface 312) on the power tool. An identification resistor 3508 is coupled to a negative battery terminal 3510. The identification resistor 3508 is configured to have a resistance value associated with an identity of the battery pack 3500.

In some implementations, the controller 304 couples a voltage to a dividing resistor in the power tool. Upon the controller 304 coupling the voltage to the dividing resistor, an identification voltage can be sensed via the identification terminal 3504 which is provided back to the controller 304. While not shown, it is contemplated that an analog-to-digital converter may convert the identification voltage into a digital signal for processing by the controller 304. The identification voltage is based on the voltage output by the controller 304 divided by the dividing resistor and the identification resistor 3508. As the value of the dividing resistor is known, as well as the voltage output by the controller 304, the identification voltage only varies based on the resistance value of the identification resistor 3508. The controller 304 is configured to determine an identity of the battery pack 3500 based on the identification voltage. For example, the controller 304 may access one or more lookup tables and/or databases stored in the memory 356 to determine an identity of the battery pack 3500 based on the determined identification voltage. For example, the lookup table and/or databases may have a number of identification voltage values that are associated with an identity of a battery pack. Upon determining the battery pack identification, the power tool may modify one or more operations based on the determined identity, as described below. In some embodiments, the battery pack 3500 communicates an identification, capacity, impedance, etc., to the controller 304 over a communication line.

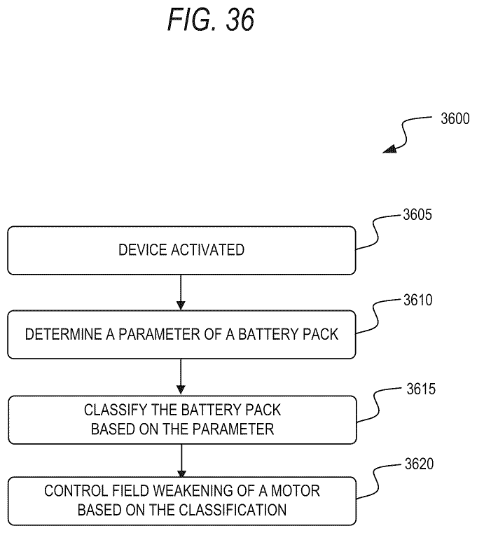

FIG. 36 illustrates a method 3600 executed by the controller 304 of the nailer 10 or another power tool. The nailer 10 is powered on (STEP 3605) to initialize the method 3600 by the controller 304. For example, the nailer 10 or other power tool may be activated by detecting activation of the trigger switch 316, which causes the rechargeable battery pack 12 to deliver power to the nailer 10 or other power tool. The controller 304 then determines a parameter of the rechargeable battery pack 12 (e.g., using one of the methods described above) (STEP 3610). A parameter of the rechargeable battery pack 12 may include, for example, a battery pack impedance, battery pack capacity (e.g., ampere-hour capacity), battery pack state-of-charge (SOC), battery pack identifier, or the like. For example, the controller 304 can receive a voltage associated with an identification resistor of the rechargeable battery pack 12. The controller 304 then assigns a classification to the rechargeable battery pack 12 based on the parameter determined in STEP 3610 (STEP 3615). A classification of the rechargeable battery pack 12 may be, for example, a high-capacity battery classification or a low-capacity battery classification. In some embodiments, the controller 304 assigns a battery a high-capacity battery classification when the battery capacity of the battery exceeds an ampere-hour threshold. In other embodiments, the controller 304 assigns a battery a low-capacity battery classification when the battery capacity of the battery is less than or equal to an ampere-hour threshold. In various embodiments, a classification is related to a determined parameter of the rechargeable battery 12.

The controller 304 then controls field weakening of the motor 308 of the nailer 10 or another power tool (e.g., using one of the methods described above) based on the classification of the rechargeable battery pack 12 (STEP 3620). For example, controlling field weakening of the motor 308 includes enabling, disabling, dynamically modifying, or setting a fixed amount of field weakening applied to the motor 308. In one instance, if the controller 304 determines that the rechargeable battery pack 12 is assigned a high-capacity classification, then the controller 304 enables field weakening of the motor 308. In this instance, if field weakening is engaged, then the controller 304 can enable dynamic control of field weakening of the motor 308 in the event of a new classification is assigned to the rechargeable battery pack 12 based on monitoring of a parameter of the rechargeable battery pack 12. In another instance, if the controller 304 determines that the rechargeable battery pack 12 is assigned a low-capacity classification, then the controller 304 disables field weakening of the motor 308. In yet another instance, if the controller 304 determines that the rechargeable battery pack 12 is assigned a low-capacity classification and field weakening is engaged, then the controller 304 can enable a reduced intensity of the field weakening of the motor 308.

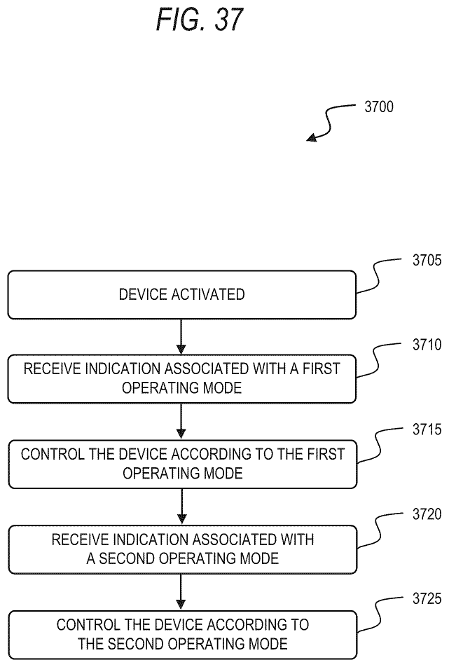

FIG. 37 illustrates a method 3700 executed by the controller 304 of the nailer 10 or another power tool to enable or disable, for example, field weakening. The nailer 10 or the other power tool is powered on (STEP 3705) to initialize the method 3700 by the controller 304. For example, the nailer 10 or other power tool may be activated by detecting activation of the trigger switch 316, which causes the rechargeable battery pack 12 to deliver power to the nailer 10 or other power tool. The controller 304 then receives an indication associated with the first operating mode input 610 of the user interface 600 (STEP 3710). The controller 304 then controls operation of the motor 308 of the nailer 10 or other power tool (e.g., using the first set of operating parameters described above in FIG. 6) (STEP 3715). The controller 304 then receives an indication associated with the second operating mode input 615 of the user interface 600 (STEP 3720). The controller 304 then controls operation of the motor 308 of the nailer 10 (e.g., using the second set of operating parameters described above in FIG. 6) (STEP 3725).

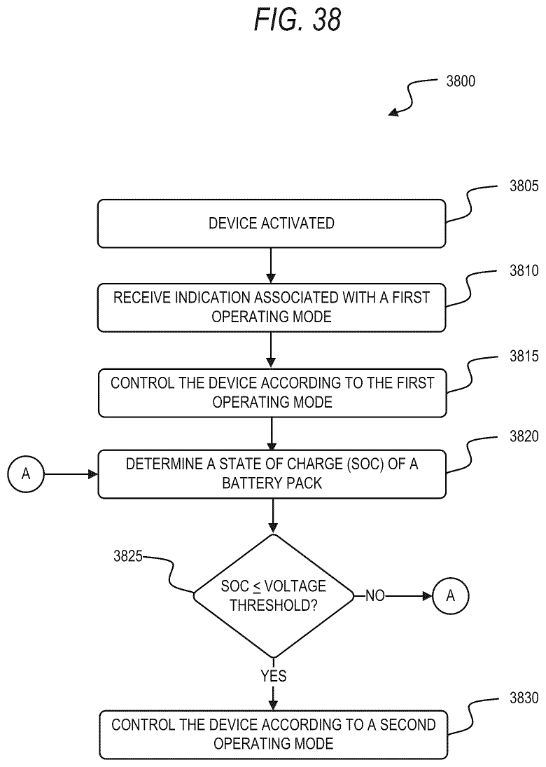

FIG. 38 illustrates a method 3800 executed by the controller 304 of the nailer 10 or another power tool. The nailer 10 or other power tool is powered on (STEP 3805) to initialize the method 3800 by the controller 304. For example, the nailer 10 or other power tool may be activated by detecting activation of the trigger switch 316, which causes the rechargeable battery pack 12 to deliver power to the nailer 10 or other power tool. The controller 304 then receives an indication associated with the first operating mode input 610 of the user interface 600 (STEP 3810). The controller 304 then controls operation of the motor 308 of the nailer 10 or other power tool (e.g., using the first set of operating parameters described above in FIG. 6) (STEP 3815). For example, the controller 304 enables field weakening of the nailer 10.

The controller 304 then receives or determines a SOC of rechargeable battery pack 12 (STEP 3820). The controller 304 compares the SOC of the rechargeable battery pack 12 to a voltage threshold (STEP 3825). If, at STEP 3825, the SOC of the rechargeable battery pack 12 is greater than the voltage threshold (STEP 3825 “NO” branch), then the controller 304 is configured to continue monitoring the SOC of the rechargeable battery pack 12. If, at STEP 3825, the SOC of the rechargeable battery pack 12 is less than the voltage threshold (STEP 3825 “YES” branch), then the controller 304 controls operation of the motor 308 of the nailer 10 or other power tool (e.g., using the second set of operating parameters described above in FIG. 6) (STEP 3830). For example, the controller 304 disables or reduces field weakening of the nailer 10 or other power tool.

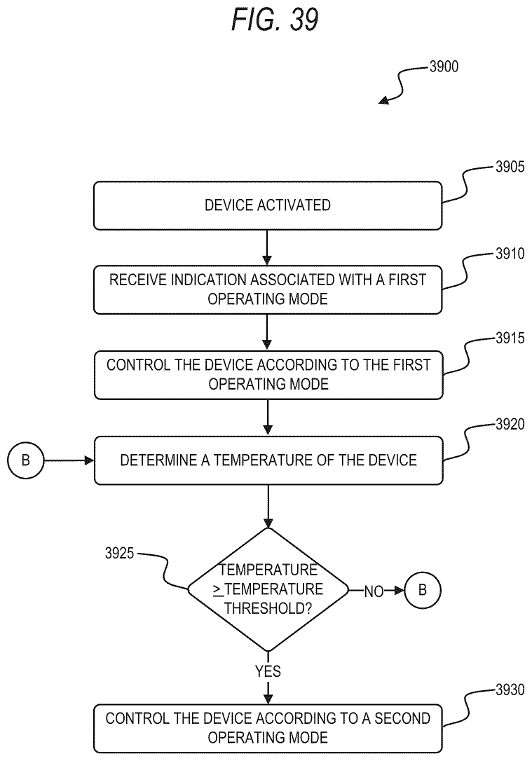

FIG. 39 illustrates a method 3900 executed by the controller 304 of the nailer 10 or another power tool. The nailer 10 or other power tool is powered on (STEP 3905) to initialize the method 3900 by the controller 304. For example, the nailer 10 or other power tool may be activated by detecting activation of the trigger switch 316, which causes the rechargeable battery pack 12 to deliver power to the nailer 10 or other power tool. The controller 304 then receives an indication associated with the first operating mode input 610 of the user interface 600 (STEP 3910). The controller 304 then controls operation of the motor 308 of the nailer 10 or other power tool (e.g., using the first set of operating parameters described above in FIG. 6) (STEP 3915). For example, the controller 304 enables field weakening of the nailer 10 or other power tool.

The controller 304 then receives or determines a temperature of the rechargeable battery pack 12 (STEP 3920). The controller 304 compares the temperature of the rechargeable battery pack 12 to a high temperature threshold (STEP 3925). If, at STEP 3925, the temperature of the rechargeable battery pack 12 is less than the high temperature threshold (STEP 3925 “NO” branch), then the controller 304 is configured to continue monitoring the temperature of the rechargeable battery pack 12. If, at STEP 3825, the temperature of the rechargeable battery pack 12 is greater than or equal to the high temperature threshold (STEP 3925 “YES” branch), then the controller 304 controls operation of the motor 308 of the nailer 10 or other power tool (e.g., using the second set of operating parameters described above in FIG. 6) (STEP 3830). For example, the controller 304 disables or reduces field weakening of the nailer 10 or other power tool.

Thus, embodiments described herein provide systems and methods for implementing sensored or sensorless field weakening in a power tool. Various features and advantages are set forth in the following claims.

1. A nailer comprising:
a housing;
a brushless motor within the housing, the brushless motor including a rotor and a stator, the rotor coupled to a motor shaft arranged to rotate about a longitudinal axis, the longitudinal axis extending through the motor shaft, the motor shaft arranged to produce a rotational output to a drive mechanism;
a power switching circuit that provides a supply of power from a battery pack to the brushless motor;
a driver blade configured to be driven by the drive mechanism between a first position and a second position; and
an electronic controller configured to:
determine whether the driver blade is in the first position, and
apply, in response to determining that the driver blade is in the first position, field weakening to the brushless motor while the driver blade is moved from the first position to the second position.

2. The nailer of claim 1, wherein the electronic controller is further configured to:
determine whether the driver blade is in the second position; and
terminate, in response to determining that the driver blade is in the second position, field weakening to the brushless motor.

3. The nailer of claim 1, further comprising:
a sensor configured to generate a sensor signal,
wherein the electronic controller is further configured to receive the sensor signal from the sensor.

4. The nailer of claim 3, wherein the electronic controller is further configured to determine whether the driver blade is in the first position based on the sensor signal.

5. (canceled)

6. (canceled)

7. The nailer of claim 1, wherein the electronic controller is further configured to:
apply a field-oriented control (“FOC”) algorithm to control the brushless motor.

8. A method of controlling a nailer including an electronic controller and a driver blade configured to be driven by a drive mechanism between a first position and a second position, the method comprising:
determining whether the driver blade is in the first position; and
applying, in response to determining that the driver blade is in the first position, field weakening to a brushless motor while the driver blade is moved from the first position to the second position.

9. The method of claim 8, further comprising:
determining whether the driver blade is in the second position; and
terminating, in response to determining that the driver blade is in the second position, field weakening to the brushless motor.

10. The method of claim 8, further comprising:
receiving, at the electronic controller, a sensor signal from a sensor.

11. The method of claim 10, further comprising:
determining whether the driver blade is in the first position based on the sensor signal.

12. (canceled)

13. (canceled)

14. The method of claim 8, further comprising:
applying a field-oriented control (“FOC”) algorithm to control the brushless motor.

15. A power tool comprising:
a housing;
a brushless motor within the housing, the brushless motor including a rotor and a stator, the rotor coupled to a motor shaft arranged to rotate about a longitudinal axis, the longitudinal axis extending through the motor shaft, the motor shaft arranged to produce a rotational output to a drive mechanism;
a power switching circuit that provides a supply of power from a battery pack interface to the brushless motor; and
an electronic controller configured to:
determine a parameter associated with the battery pack,
classify the battery pack based on the determined parameter, and
control field weakening applied to the brushless motor based on the classification of the battery pack.

16. The power tool of claim 15, wherein the electronic controller is further configured to:
apply, in response to classifying the battery pack as a high-capacity battery pack, field weakening to the brushless motor.

17. The power tool of claim 15, wherein the electronic controller is further configured to:
disable, in response to classifying the battery pack as a low-capacity battery pack, field weakening to the brushless motor.

18. The power tool of claim 15, wherein the electronic controller is further configured to:
adjust the field weakening applied to the brushless motor based the parameter associated with the battery pack.

19. The power tool of claim 18, wherein:
the parameter is a state-of-charge of the battery pack; and
the electronic controller is further configured to:
adjust the field weakening applied to the brushless motor based on the state-of-charge of the battery pack.

20. The power tool of claim 18, wherein:
the parameter is a temperature of the battery pack; and
the electronic controller is further configured to:
adjust the field weakening applied to the brushless motor based on the temperature of the battery pack.

21. The power tool of claim 15, wherein the electronic controller is further configured to:
receive a first indication associated with a first operating mode of the power tool, the first operating mode including a first set of operating parameters that enable field weakening;
control, in response to receiving the first indication associated with the first operating mode of the power tool, operation of the brushless motor according to the first operating mode;
receive a second indication associated with a second operating mode of the power tool, the second operating mode including a second set of operating parameters that disable field weakening; and
control, in response to receiving the second indication associated with the second operating mode of the power tool, operation of the brushless motor according to the second operating mode.

22. The power tool of claim 15, wherein the parameter associated with the battery pack is an identification of the battery pack.

23. The power tool of claim 15, wherein the parameter associated with the battery pack is an impedance of the battery pack.

24. The power tool of claim 15, wherein the parameter associated with the battery pack is an ampere-hour capacity of the battery pack.

25-34. (canceled)
